(19) United States
(12) Patent Application Publication
(10) Pub. No.: US 2016/0156568 A1
(43) Pub. Date: Jun. 2, 2016

(54) COMPUTER SYSTEM AND COMPUTER RESOURCE ALLOCATION MANAGEMENT METHOD

(71) Applicant: Hitachi, Ltd., Tokyo (JP)

(72) Inventors: Yuki NAGANUMA, Tokyo (JP); Noriko NAKAJIMA, Tokyo (JP); Soichi TAKASHIGE, Tokyo (JP); Tomohiro MORIMURA, Tokyo (JP)

(21) Appl. No.: 14/636,212

(22) Filed: Mar. 3, 2015

(30) Foreign Application Priority Data
Nov. 27, 2014 (JP) 2014-240529

(51) Int. Cl. H04L 12/911; H04L 29/08

(52) U.S. Cl. CPC H04L 47/70; H04L 67/1002

(57) ABSTRACT

A computer system comprising computers, wherein the computers include a first computer and second computers for providing resources to a business system. The business system includes a first VM capable of changing its performance by executing scale-out, and a second VMs capable of changing their performance by executing scale-up. The resource optimizing module included in the first computer is configured to: execute first processing for applying resource changing methods that are light in processing load to the active second VM and the standby second VM in a case of detecting an incident of an increase in load on the active second VM; and execute second processing for applying resource changing methods that are heavy in processing load to the active second VM and the standby second VM in a case of increasing the load on the active second VM.

### CLAIM OF PRIORITY

The present application claims priority from Japanese patent application JP 2014-240529 filed on Nov. 27, 2014, the content of which is hereby incorporated by reference into this application.

### BACKGROUND OF THE INVENTION

This invention relates to a cloud service, and more particularly, to guaranteeing the performance of an IT service or an IT system that is provided in a cloud service.

Services called cloud service have become popular in recent years. In a cloud service, an entity running the cloud service provides the service over a network such as the Internet via computer resources or software that uses computer resources to operate, and charges users fees that are determined by the mode of use.

Cloud services are classified, from the viewpoint of the mode in which the service is provided, into Infrastructure as a Service (IaaS), Software as a Service (SaaS), Platform as a Service (PaaS), and others.

IaaS is a cloud service that provides computer resources themselves. SaaS is a cloud service that provides, as software, an e-mail function, a customer management function, or other functions by a method that allows for access mainly from Web browsers. PaaS is in between IaaS and SaaS, and is a cloud service that provides a foundation for the development of software including middleware, such as an operating system (OS) and a database (hereinafter abbreviated as DB).

In most cloud services, computer resources provided in IaaS, or computer resources that constitute the foundation of PaaS or SaaS, generally use a virtualization technology called server virtualization. Server virtualization logically partitions a central processing unit (CPU), a memory, and other computer resources of a physical server, and uses the partitioned computer resources in units of virtual server (VM).

There are known cloud services that provide a function of executing automatic or manual scaling of VMs depending on the load condition or the like in order to make use of virtualized computer resources. An example of this type of cloud service monitors the load on the CPU or other components and, when the load exceeds a threshold, provides a scale-out technology with which VMs that execute processing are added in order to distribute processing. Flexible utilization of computer resources and improvement in VM performance are accomplished in this manner.

In the most recent years, a configuration is beginning to gain popularity in which, before processing completes in one cloud service, a plurality of other cloud services are joined together to build one large service.

### SUMMARY OF THE INVENTION

JP 2012-99062 A includes the following description: “A cloud that executes an intermediate service uses an output rate predicting module to receive a predicted output 407 of an upstream service and, from a cloud management server 401, information collection response 404 and the like, to predict an output rate, and to output the prediction to a downstream service. A scaling control module receives the predicted output 407 of the upstream service and information collection response 405, determines resources to be allocated to the intermediate service, and outputs a scaling request to the cloud management server 401 and the output rate predicting module.”

According to JP 2012-99062 A, in a service 1 and a service 2 which are joined, the service 2 which is the back end can be scaled out (by adding VMs) when an increase in scale or request number is detected in the service 1 which is the front end.

On the other hand, the technology disclosed in JP 2012-99062 A is targeted for cooperation between components that are capable of scaling out, namely, components that can be improved in processing performance by adding VMs. The technology is therefore not applicable to a system that includes components incapable of scaling out.

For example, in a three-tier Web system that includes at least one Web server, at least one application server, and one DB server which executes database processing, while automatic scaling of the Web server is feasible with the use of the technology of JP 2012-99062 A, the DB server cannot be partitioned into a plurality of pieces for reasons including data consistency, which means that scaling out by processing of adding a DB server or by other types of processing does not improve performance. The technology of JP 2012-99062 A therefore has a problem in that this technology fails to accomplish automatic scaling of the overall system and consequently cannot improve performance in three-tier Web systems that have the limitations described above.

Another possible method of improving the performance of a DB server is to enhance a CPU, a memory, and other computer resources for the DB server. With this method, however, a change in computer resources is undesirably accompanied by a reboot of the DB server. Because the time from a change in computer resources to a reboot of the DB server is long, the method cannot follow the scaling out of a Web server which is finished in a relatively short time.

Consequently, a three-tier Web system that executes an online shopping service, for example, cannot flexibly deal with a sudden increase in the number of users of the service, and suffers a loss of opportunity from system down or from the rejection of requests (displaying a “sorry” page) due to the concentration of load.

Still another possible method of improving the performance of a DB server is to build a business system that is a three-tier Web system or the like with the use of an abundance of computer resources from the beginning. A problem of this method is an increased cost to an entity that runs an online shopping business or other operations.

The present invention can be appreciated by the description which follows in conjunction with the following figures, wherein: a computer system, comprising a plurality of computers, wherein the plurality of computers include at least one first computer for managing the computer system, and a plurality of second computers for providing computer resources from which a business system used for a user's business operation is built. The at least one first computer includes a first processor, a first memory which is coupled to the first processor, and a first interface which is coupled to the first processor. Each of the plurality of second computers includes a second processor, a second memory which is coupled to the second processor, a second interface which is coupled to the second processor, and a storage apparatus. The business system includes at least one of a first business computer capable of changing its processing performance by executing scale-out processing, and a plurality of second business computers capable of changing their processing performance by executing scale-up processing. The plurality of second business computers form at least one of a cluster including at least one of an active second business computer and at least one of a standby second business computer. The at least one first computer includes a resource optimizing module configured to manage a plurality of resource changing methods for controlling changes in allocation of the computer resources to the plurality of second business computers, and change the allocation of the computer resources to the plurality of second business computers based on the plurality of resource changing methods. The resource optimizing module is configured to: monitor load on the business system; execute first processing for applying resource changing methods that are light in processing load to the at least one of the active second business computer and the at least one of the standby second business computer in a case of detecting an incident of an increase in load on the at least one of the active second business computer; and execute second processing for applying resource changing methods that are heavy in processing load to the at least one of the active second business computer and the at least one of the standby second business computer in a case where a value indicating the load on the at least one of the active second business computer reaches a given threshold or higher.

According to one embodiment of this invention, automatic scaling of a business system is accomplished while minimizing impact on a business in the business system and keeping the cost low, even when the business system includes a configuration that is incompatible with scale-out processing.

### BRIEF DESCRIPTION OF THE DRAWINGS

The present invention can be appreciated by the description which follows in conjunction with the following figures, wherein:

FIG. 1 is an explanatory diagram outlining a first embodiment of this invention;

FIG. 2 is an explanatory diagram illustrating an example of a cloud service of the first embodiment;

FIG. 3 is an explanatory diagram illustrating a configuration example of a computer system that provides a cloud service according to the first embodiment;

FIG. 4 is an explanatory diagram illustrating an example of the hardware configuration of a management server according to the first embodiment;

FIG. 5 is an explanatory diagram illustrating an example of the configuration of a storage apparatus according to the first embodiment;

FIG. 6 is an explanatory diagram showing an example of physical server management information according to the first embodiment;

FIG. 7 is an explanatory diagram showing an example of storage management information according to the first embodiment;

FIG. 8 is an explanatory diagram showing an example of virtual-physical configuration management information according to the first embodiment;

FIG. 9 is an explanatory diagram showing an example of tenant management information according to the first embodiment;

FIG. 10 is an explanatory diagram showing an example of performance management information according to the first embodiment;

FIG. 11 is an explanatory diagram showing an example of system template management information according to the first embodiment;

FIG. 12 is an explanatory diagram showing an example of customer management information according to the first embodiment;

FIG. 13 is an explanatory diagram showing an example of scale management information according to the first embodiment;

FIG. 14 is an explanatory diagram showing an example of resource changing method management information according to the first embodiment;

FIG. 15 is a flow chart outlining processing that is executed by a resource optimizing program of the first embodiment;

FIGS. 16A and 16B are flow charts illustrating details of the processing of scaling up DB servers which is executed in Step S3200 by the resource optimizing program of the first embodiment;

FIG. 17 is a flow chart illustrating the processing of relocating VMs which is executed by the resource optimizing program of the first embodiment;

FIG. 18 is a flow chart illustrating details of the processing of scaling up the DB servers which includes takeover processing and which is executed by the resource optimizing program of the first embodiment;

FIG. 19 is a flow chart illustrating details of processing of scaling down the scaled up DB servers which is executed by the resource optimizing program of the first embodiment

FIG. 20 is an explanatory diagram illustrating an example of a screen that is used to sign up for a service in the first embodiment; and

FIG. 21 is an explanatory diagram illustrating an example of a screen that is displayed in order to check the state of tenant according to the first embodiment.

### DETAILED DESCRIPTION OF THE PREFERRED EMBODIMENT

An embodiment of this invention is described below with reference to the drawings.

### First Embodiment

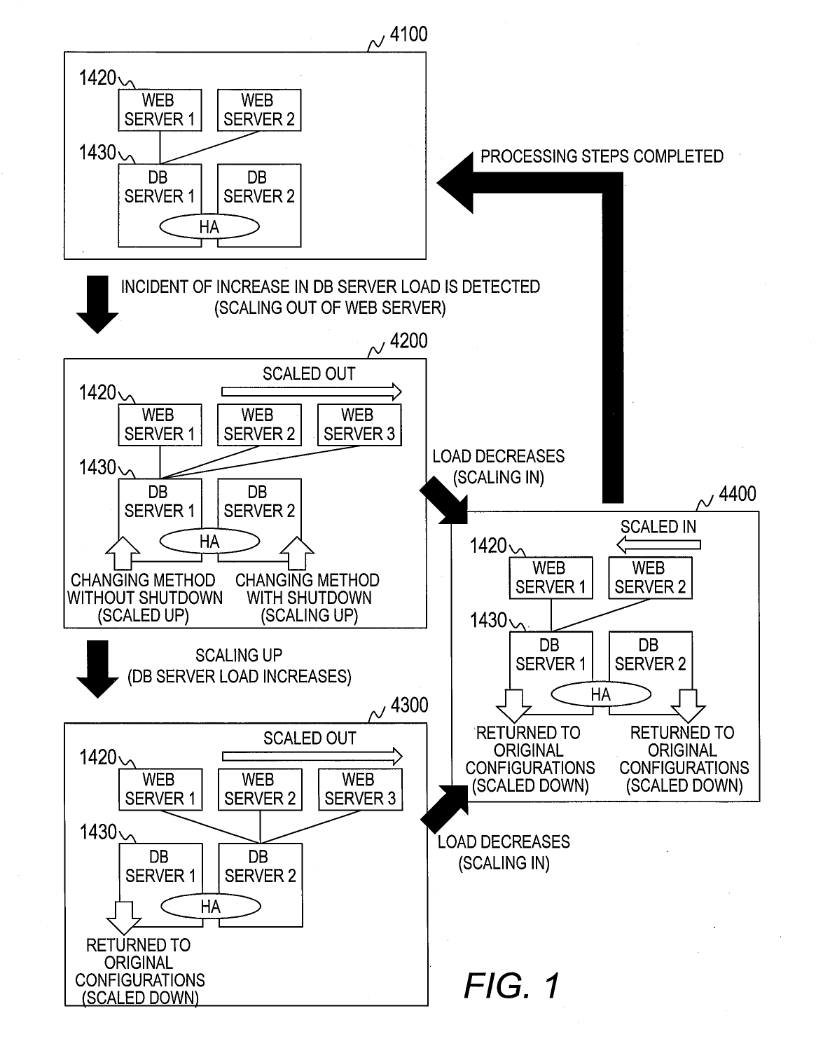

FIG. 1 is an explanatory diagram outlining a first embodiment of this invention.

The first embodiment deals with a tenant (business system) 1400 which includes two Web servers 1420 and two DB servers 1430. The tenant 1400 is initially in a state 4100.

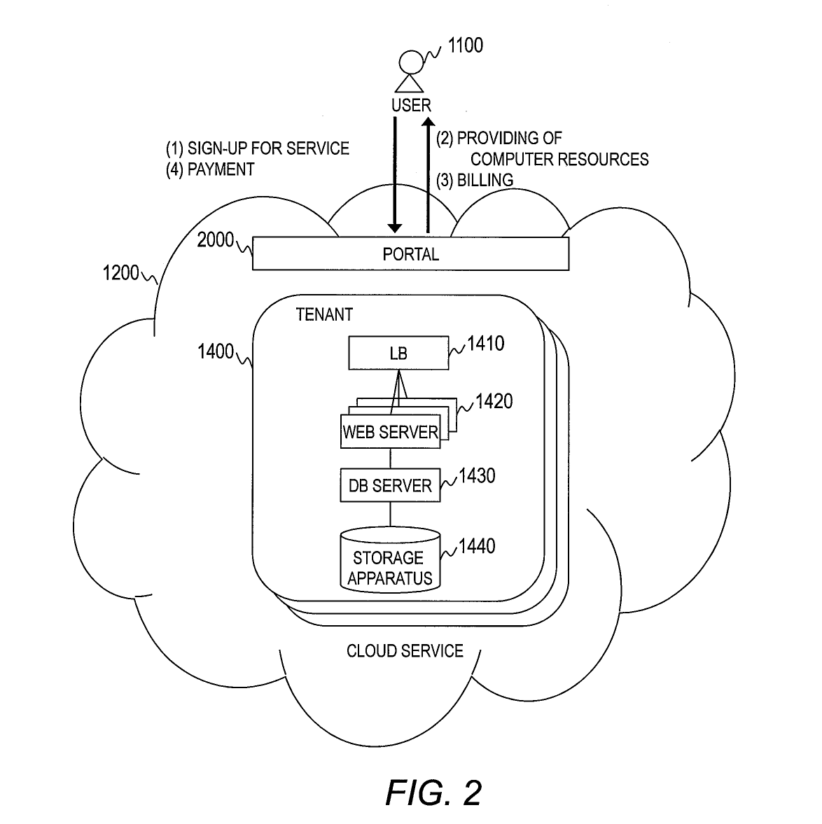

The tenant 1400 is a computer resource space provided to each user 1100 by a computer system that provides a cloud service 1200 as the one illustrated in FIG. 2. The Web servers 1420 and the DB servers 1430 are therefore implemented with the use of a virtualization technology.

In the tenant 1400 that is in the state 4100, the two DB servers 1430 construct a high availability (HA) configuration (server redundancy configuration). Here, DB Server 1 (1430) out of the two DB servers 1430 of the HA configuration operates as a primary (active) DB server, and DB Server 2 (1430) operates as a secondary (standby) DB server.

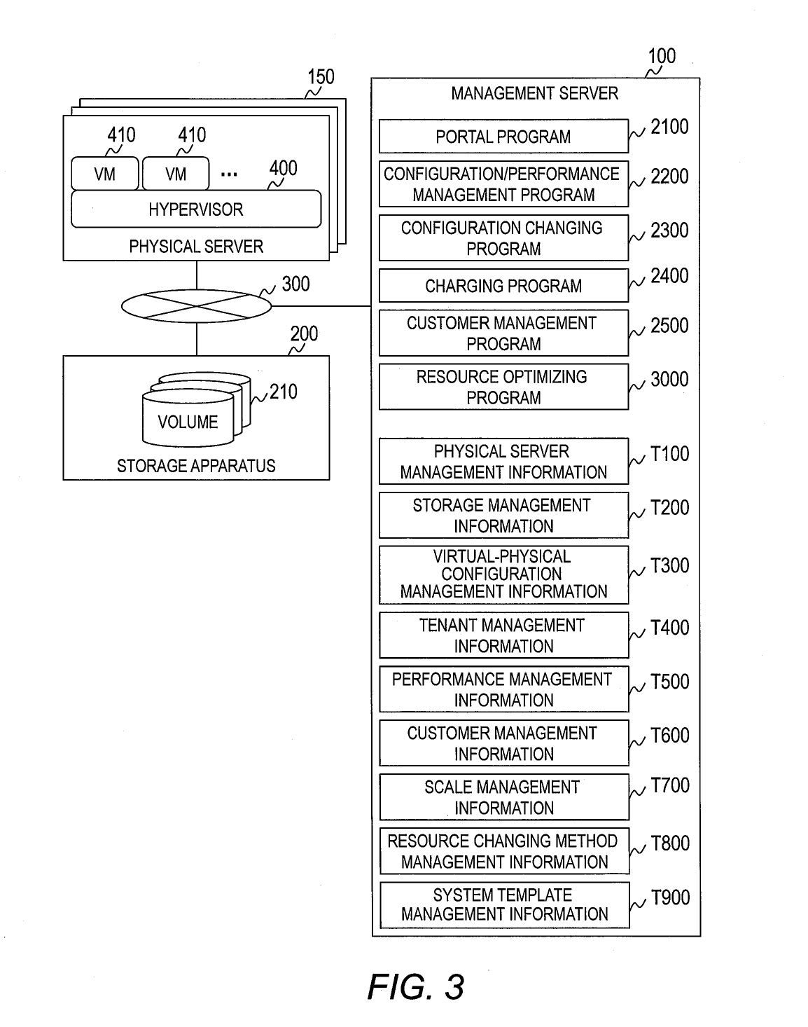

In a case where an incident of an increase in load on the active DB server 1430 is detected when the tenant 1400 is in use, a management server 100, which is illustrated in FIG. 3, executes processing that is described later, thereby causing the tenant 1400 to shift from the state 4100 to a state 4200. For instance, in a case where the Web servers 1420 are scaled out in order to deal with increased load on the front end, the management server 100 causes the tenant 1400 to shift from the state 4100 to the state 4200.

In the state 4200, the Web servers 1420 are scaled out by adding Web Server 3 (1420). The DB servers 1430 are scaled up as well. The management server 100 scales up the DB servers 1430 by employing a scale-up method that does not involve shutting down the DB server (changing method without shutdown) for DB Server 1 (1430) which is the primary DB server, and employing a scale-up method that involves shutting down the DB server (changing method with shutdown) for DB Server 2 (1430) which is the secondary DB server. Employing the scale-up method that does not involve shutdown for DB Server 1 (the primary DB server 1430) improves performance while allowing DB Server 1 (1430) to keep running.

The management server 100 in this case scales up DB Server 2 (the secondary DB server 1430) so that DB Server 2 (1430) is higher in performance than DB Server 1 (the primary DB server 1430) in order to deal with an increased load on DB Server 1 (the primary DB server 1430).

In a case where the load on DB Server 1 (1430) increases after the shift to the state 4200, the management server 100 executes processing that is described later, thereby causing the tenant 1400 to shift from the state 4200 to a state 4300. For example, in a case where the utilization ratio of computer resources that are allocated to the scaled up DB Server 1 (1430) reaches a given threshold or higher, or in a case where a performance failure occurs in DB Server 1 (1430), the management server 100 causes the tenant 1400 to shift from the state 4200 to the state 4300.

In the state 4300, the management server 100 executes takeover processing or the like, to thereby make a switch from DB Server 1 (1430) to DB Server 2 (1430) which has undergone an optimum scale up during the shift to the state 4200. This enables DB Server 2 (1430) which is higher in performance than DB Server 1 (1430) to continue processing.

After the switch from DB Server 1 (1430) to DB Server 2 (1430), the management server 100 also executes scaling down in the state 4300 in order to return computer resource configurations of DB Server 1 (1430) which have been changed in the state 4200 to the original configurations. In other words, the configurations of computer resource such as those added to DB Server 1 (1430) are initialized. Returning computer resource allocation to DB Server 1 (1430) to the original allocation allows the computer system that provides the cloud service 1200 to make full use of the system's computer resources.

In the case where the load on the active DB server 1430 decreases in the state 4200 or the state 4300, the management server 100 executes processing that is described later, thereby causing the tenant 1400 to shift to a state 4400 from the state 4200, or from the state 4300.

For example, in a case where the Web servers 1420 are scaled in in response to a decrease in load on the front end, the management server 100 causes the tenant 1400 to shift to the state 4400 from the state 4200 or from the state 4300. In FIG. 1, scaling in to remove Web Server 3 (1420) from the tenant 1400 is executed. The management server 100 in this case scales down DB Server 1 (1430) and DB Server 2 (1430) separately in order to return the computer resource configurations that have been changed in the scaling up to the original configurations.

The management server 100 returns the respective computer resource configurations of DB Server 1 (1430) and DB Server 2 (1430) to the original configurations in the shift from the state 4200 to the state 4400. In the shift to the state 4400 from the state 4300, where the computer resource configurations of DB Server 1 (1430) have been initialized, the management server 100 returns the computer resource configurations of DB Server 2 (1430) to the original state.

In the first embodiment, the management server 100 executes the series of processing steps described above to cause a shift from the state 4400 to the state 4100. In other words, the state of the tenant 1400 cycles through the states 4100, 4200, 4300, and 4400 depending on the load on the tenant 1400.

FIG. 2 is an explanatory diagram illustrating an example of the cloud service of the first embodiment.

The use of the cloud service 1200 and processing in the cloud service 1200 are described from the viewpoint of the user 1100. Concrete behavior of the computer system that provides the cloud service 1200 is described later.

The cloud service 1200 includes a portal 2000 and a plurality of tenants 1400.

The portal 2000 is a management interface through which the user 100 signs up for a service of the cloud service 1200 and manages the relevant tenant 1400. The user 1100 uses the portal 2000 to sign up for a service that the user 1100 intends to use, to manage the relevant tenant 1400, and the like.

While the user 1100 conducts the management of the relevant tenant 1400 and the like via the portal 2000 in the first embodiment, other methods may be used to sign up for a service and to manage the tenant 1400. A method that uses e-mail or a paper medium is an example of alternatives. The cloud service 1200 in this case does not need to include the portal 2000.

In a case of receiving a request to sign up for a service from the user 1100, the cloud service 1200 prepares computer resources called for by the service for the tenant 1400 that is allocated as a computer resource space exclusive to the user 1100. One user 1100 is allocated one or more tenants 1400 depending on what service the user 1100 signs up for.

In the case where the user 1100 signs up for a three-tier Web system in the cloud service 1200 that is IaaS or PaaS, the tenant 1400 that is built includes a load balancer (LB) 1410, the Web servers 1420 which have a Web function, the DB servers 1430 which have a DB function, and a storage apparatus 1440 which provides a storage area. In the case where an e-mail service is signed up for in the cloud service 1200 that is SaaS, the e-mail service is provided by software included in the tenant 1400 that implements a three-tier Web system.

After finishing building the tenant 1400, the cloud service 1200 notifies the user 1100 of that fact via the portal 2000. The user 1100 manages the tenant 1400 with the use of the portal 2000 or other methods from then on.

The tenant 1400 is also the unit of charging the user 1100 a fee. The cloud service 1200 periodically calculates the amount of usage fee based on a fee structure that is agreed upon at the time of signing up for the service, and charges the user 1100 the amount of usage fee via the portal 2000 or other methods. In a case of being billed the amount of usage fee, the user 1100 pays the billed amount via the portal 2000, or by a settlement method specified via the portal 2000.

Examples of the fee structure include one in which the user 1100 pays a fixed amount of usage fee monthly, and one in which the user 1100 pays a usage fee on a metered basis which is calculated from the specifications of a VM that has been used, the size of the storage area that has been used, or the like.

The cloud service 1200 of the first embodiment is compatible with multi-tenant. Multi-tenant provides at least one tenant 1400 to each of a plurality of users. In the cloud service 1200 that is compatible with multi-tenant, it is important for an entity that provides the service in question to manage computer resources so that a service level agreement (SAL) demanded by the user 1100 is fulfilled. Attaining this is one of main objects of this invention.

FIG. 3 is an explanatory diagram illustrating a configuration example of the computer system that provides the cloud service 1200 according to the first embodiment.

The computer system that provides the cloud service 1200 includes the management server 100, a plurality of physical servers 150, and a storage apparatus 200. The management server 100, the plurality of physical servers 150, and the storage apparatus 200 are coupled to one another via a network 300.

The network 300 can be, for example, the Ethernet (a registered trademark, hereinafter referred to as “the Ethernet®”). In the case where the physical servers 150 and the storage apparatus 200 are coupled to each other via a SAN, the network 300 may include the SAN and the Ethernet® both, or may be the Internet.

The network 300 may also include a management-use network over which the management server 100 holds communication for controlling the physical servers 150 and the storage apparatus 200, and a business operation-use network over which the physical servers 150 and the storage apparatus 200 hold communication to and from each other.

The network 300 may be compatible with a virtual network (also called a VLAN) technology which logically partitions a single network in order to provide the tenant 1400 for each user 1100 and to separate management-use communication from communication of the user 1100. The entity that provides the cloud service 1200 sets a virtual network when the user 1100 signs up for a service, and provides the tenant 1400 as an independent business operation system with the use of the network created by logical partitioning and a VM 410 coupled via this network.

The physical servers 150 are computers that provide computer resources to the tenant 1400 of the user 1100. A hypervisor 400 runs on each physical server 150. The hypervisor 400 logically partitions a CPU, a memory, and other computer resources that the physical server 150 possesses, and allocates the partitioned resources to a plurality of VMs 410. At least one VM 410 to which the computer resources of the physical server 150 are allocated operates on the hypervisor 400.

While a premise of the description of the first embodiment is that the physical servers 150 are compatible with the virtualization technology, the physical servers 150 may not be compatible with the virtualization technology. In this case, resource changing method management information T800 which is described later stores a changing method that is applicable to the physical servers 150 themselves.

The storage apparatus 200 is a computer that provides volumes 210 as storage areas used by the VMs 410 which run on the physical servers 150. The volumes 210 store a program that implements the hypervisor 400, information necessary for the hypervisor 400 to run, configuration information of the VMs 410, an OS executed on the VMs 410, user data, and the like.

The volumes 210 and the VMs 410 may have an association relation that allocates one volume 210 to one VM 410, or an association relation that allocates one volume 210 to a plurality of VMs 410, or an association relation that allocates a plurality of volumes 210 to one VM 410.

The storage apparatus 200 which is, in FIG. 3, an external storage apparatus coupled by a storage area network (SAN) or network attached storage (NAS), a popular way to implement the HA configuration of the DB servers 1430, is not limited thereto. For example, the physical servers 150 may contain the storage apparatus 200, or HDDs or other storage apparatus that the physical servers 150 has may be used as the storage apparatus 200.

The management server 100 is a computer for managing the overall computer system that provides the cloud service 1200. The management server 100 holds programs and various types of information for executing various types of control. The management server 100 which is illustrated as a single physical computer in FIG. 3 may be implemented with the use of one or more VMs 410. Functions of the management server 100 may be implemented by arranging the programs and the information in a distributed manner among the plurality of physical servers 150.

The programs and the information that are held on the management server 100 are described.

The management server 100 holds a portal program 2100, a configuration/performance management program 2200, a configuration changing program 2300, a charging program 2400, a customer management program 2500, and a resource optimizing program 3000. The management server 100 also holds physical server management information T100, storage management information T200, virtual-physical configuration management information T300, tenant management information T400, performance management information T500, customer management information T600, scale management information T700, the resource changing method management information T800, and system template management information T900.

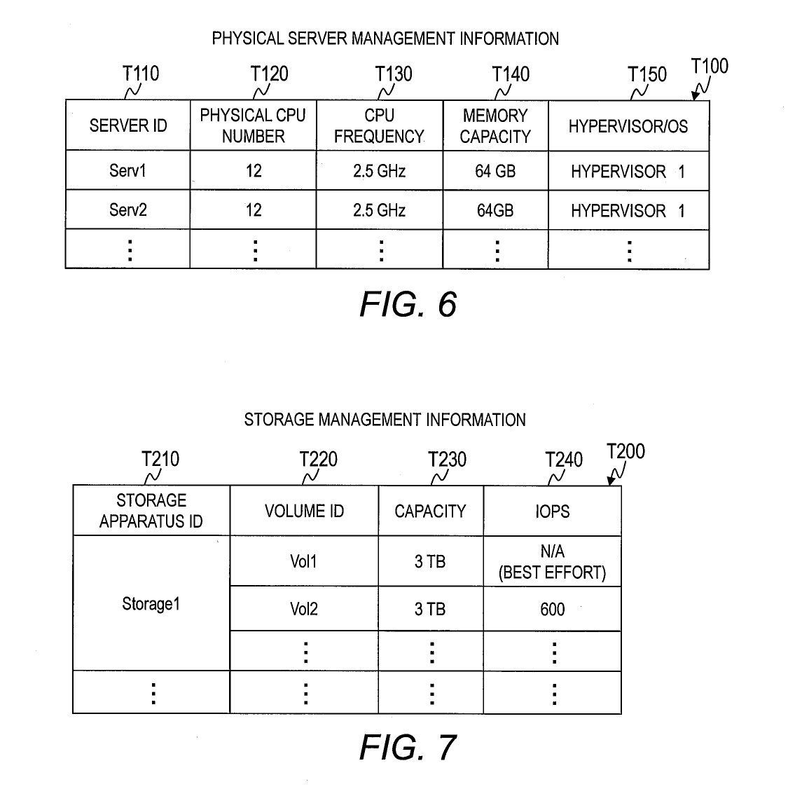

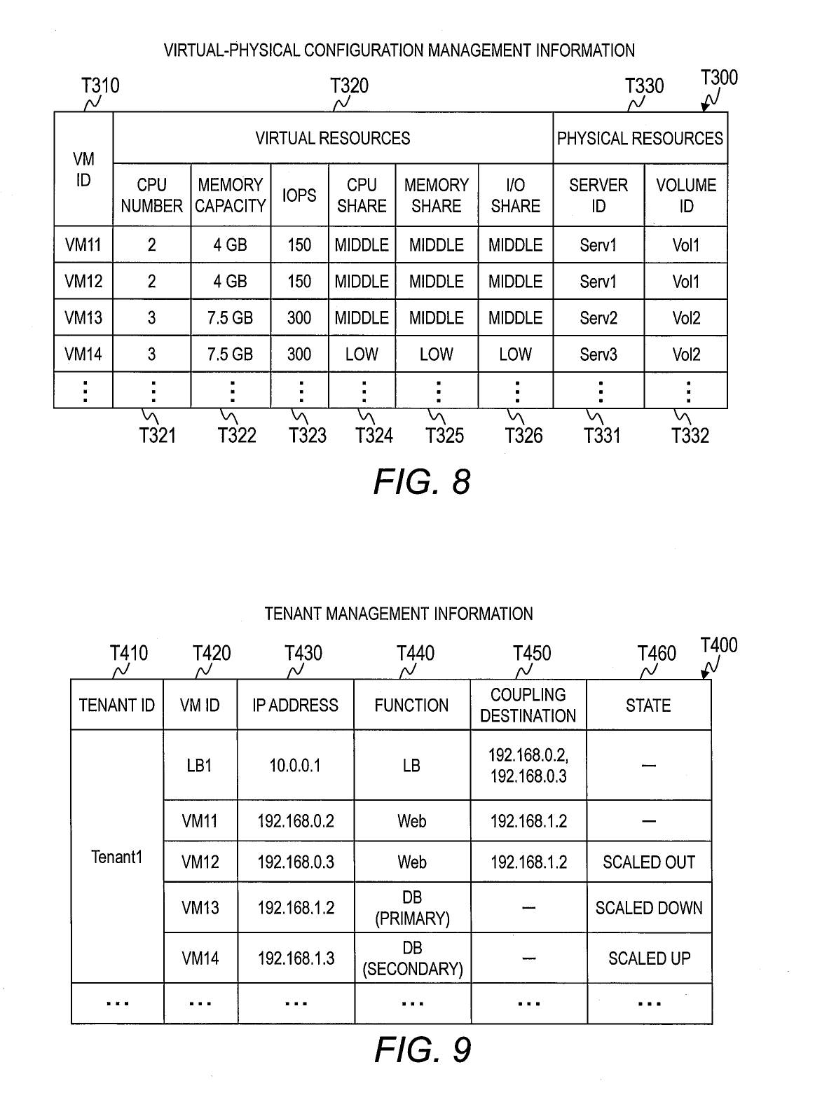

The physical server management information T100 is information for managing the configuration of the physical servers 150. Details of the physical server management information T100 are described later with reference to FIG. 6. The storage management information T200 is information for managing the volumes 200 which are provided by the storage apparatus 200. Details of the storage management information T200 are described later with reference to FIG. 7. The virtual-physical configuration management information T300 is information for managing the configuration of the VMs 410 which are included in the computer system and for managing the physical placement of the VMs 410. Details of the virtual-physical configuration management information T300 are described later with reference to FIG. 8.

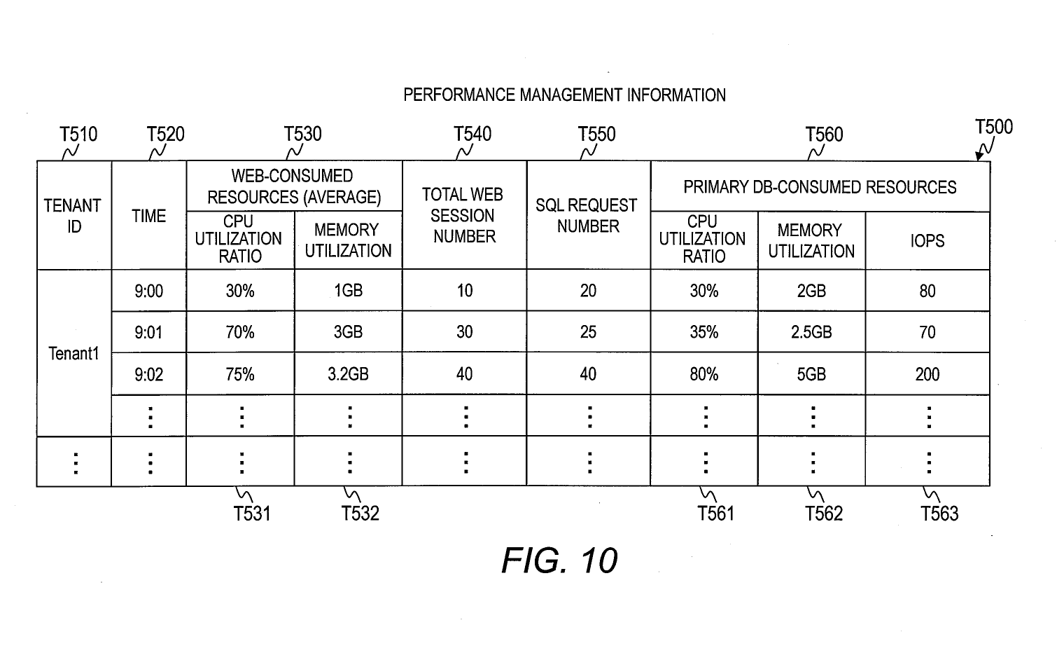

The tenant management information T400 is information for managing the configuration of the tenant 1400 that is built in the computer system. Details of the tenant management information T400 are described later with reference to FIG. 9. The performance management information T500 is information for managing the performance of the tenant 1400. Details of the performance management information T500 are described later with reference to FIG. 10.

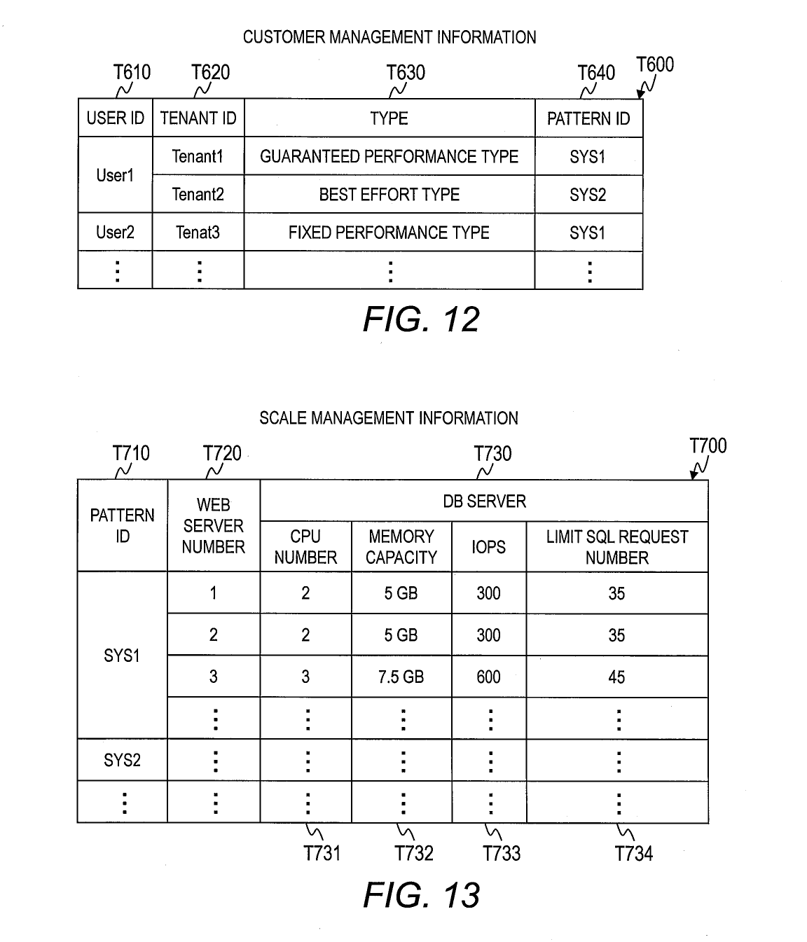

The customer management information T600 is information for managing, for each user 1100, the contract mode and the like of the tenant 1400 that is provided to the user 1100. Details of the customer management information T600 are described later with reference to FIG. 12. The scale management information T700 is information for managing, for each business operation system, the computer resource configuration of VMs that constitute the business operation system. Details of the scale management information T700 are described later with reference to FIG. 13.

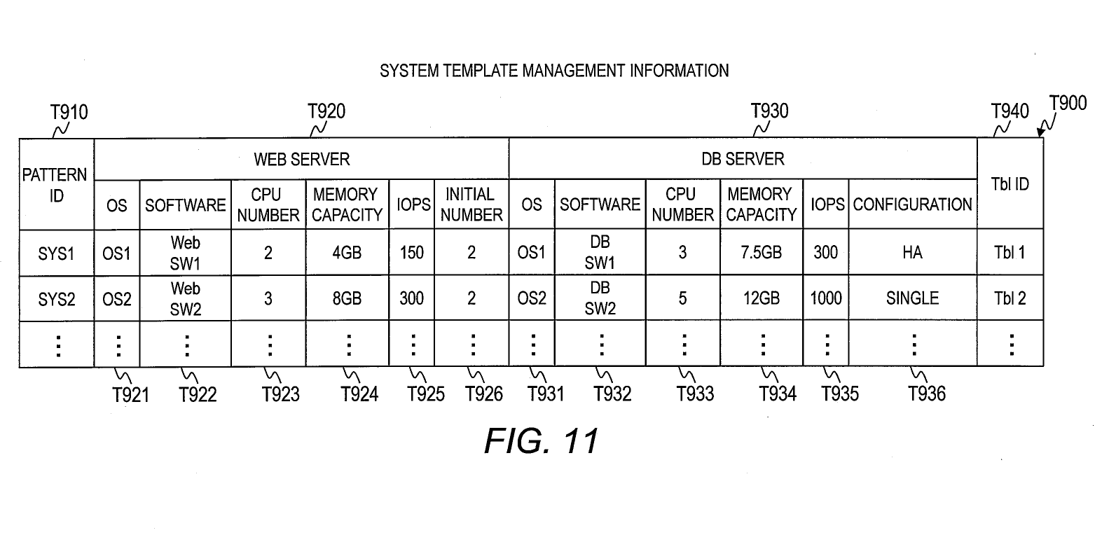

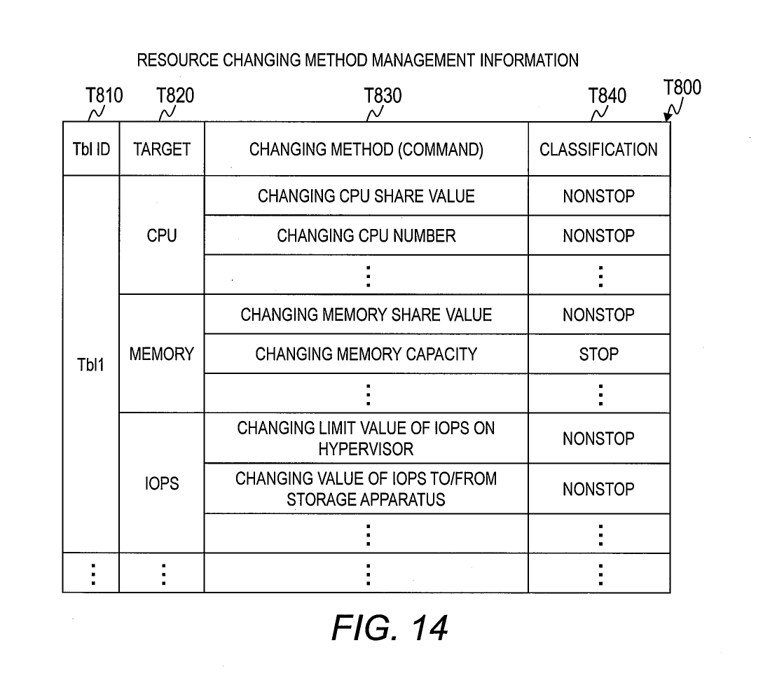

The resource changing method management information T800 is information for managing computer resource changing methods. A computer resource changing method here is a method of controlling a change in computer resource allocation to the VMs 410 or the like. Details of the resource changing method management information T800 are described later with reference to FIG. 14. The system template management information T900 is information for managing, for each business operation system, a detailed configuration of the business operation system. Details of the system template management information T900 are described later with reference to FIG. 11.

The portal program 2100 is a program for implementing the portal 2000 which is provided to the user 1100. Specifically, the portal program 2100 displays a screen or the like for presenting to the user 1100 information necessary to sign up for a service and other types of information. The portal program 2100 also notifies information input by the user 1100 to other programs and requests the programs to process the information.

The configuration/performance management program 2200 is a program for managing configuration information and performance information of the physical servers 150, the hypervisor 400, the VMs 410, the network 300, the storage apparatus 200, and the volumes 210. The configuration/performance management program 2200 obtains various types of information from the physical servers 150, the storage apparatus 200, and others to manage the obtained information as management information. Specifically, the configuration/performance management program 2200 manages the physical server management information T100, the storage management information T200, the virtual-physical configuration management information T300, the tenant management information T400, and the performance management information T500.

The configuration changing program 2300 is a program that executes processing of changing the computer resource configuration in the computer system by following an instruction from the portal program 2100 or the resource optimizing program 3000. Based on the result of the processing, the configuration changing program 2300 updates various types of information or instructs relevant programs to update their respective pieces of information.

The configuration changing program 2300 also has a function for executing changing processing. For instance, in a case of receiving an instruction or the like to change the CPU number of one VM 410, the configuration changing program 2300 calls up a command and sub-program for executing this instruction which are held inside the configuration changing program 2300, and executes configuration changing processing for the VM 410 or the hypervisor 400.

The configuration changing program 2300 also manages the system template management information T900. The configuration changing program 2300 uses the system template management information T900 to build the tenant 1400 that implements a specified business operation system. For example, in the case where a three-tier Web system is specified as the business operation system, the configuration changing program 2300 refers to a record of the system template management information T900 that corresponds to the three-tier Web system, and executes processing for building the business operation system. The processing of building a business operation system with the use of the system template management information T900 can be, for example, one disclosed in JP 2012-99062 A.

The charging program 2400 follows an instruction from the configuration/performance management program 2200 to calculate, for each user 1100, the amount of usage fee based on the various types of management information, and charges the user the amount of usage fee via the portal program 2100 or the like.

The customer management program 2500 manages contract information and the like of each user 1100. The customer management program 2500 specifically manages the customer management information T600. For example, the customer management program 2500 stores the identifier of the user 1100, the identifier of the relevant tenant 1400, the contract mode of the tenant, and other types of information that are received from the portal program 2100 or the like in the customer management information T600 in association with one another. In the case where an inquiry about contract information of the user 1100 is received from another program, the customer management program 2500 refers to the customer management information T600 to respond to the inquiry.

The resource optimizing program 3000 controls, in conjunction with the configuration/performance management program 2200 or the like, computer resource allocation to the tenants 1400 in scale-up processing and similar processing. Details of the processing that is executed by the resource optimizing program 3000 are described later. The resource optimizing program 3000 also manages the scale management information T700 and the resource changing method management information T800.

While the various types of management information are managed as individual pieces of information, an alternative configuration may be employed. For instance, all types of management information may be stored in a shared storage area (database) so that each program separately makes an inquiry to the database.

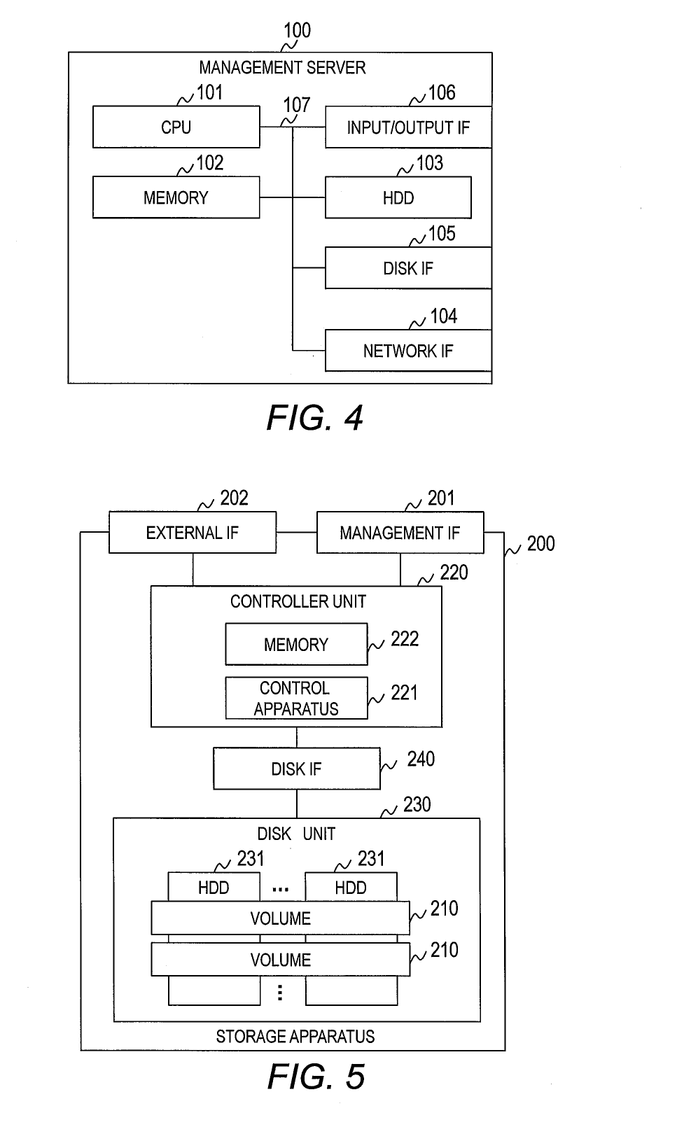

FIG. 4 is an explanatory diagram illustrating an example of the hardware configuration of the management server 100 according to the first embodiment. The physical servers 150 have the same hardware configuration as that of the management server 100.

The management server 100 includes a CPU 101, a memory 102, an HDD 103, a network interface 104, a disk interface 105, and an input/output interface 106. The components of the management server 100 are connected to one another by an internal bus 107. Through the internal bus 107, the components of the management server 100 hold communication to and from one another.

The CPU 101 executes programs stored in the memory 102. The CPU 101 has a plurality of cores which execute computing processing. The functions of the management server 100 are implemented by the CPU 101 by executing the programs. When a description given here on processing has a program as the nominative, it means that the program is executed by the CPU 101.

The memory 102 stores programs executed by the CPU 101 and information necessary to execute the programs. The memory 102 includes a storage area for providing a work area that is used by the programs.

The memory 102 of the management server 100 stores the programs and the pieces of information that are illustrated in FIG. 3. The memory 102 of each physical server 150 stores a program that implements the hypervisor 400, a program that implements an OS running on the VMs 410, and the like.

The hard disk drive (HDD) 103 stores various types of data and various types of information. The management server 100 may have a solid state drive (SSD) or other storage media in addition to the HDD 103. The programs and information stored in the memory 102 may be stored in the HDD 103. In this case, the CPU 101 reads the programs and the information out of the HDD 103 and loads the read programs and information onto the memory 102.

The network interface 104 is an interface for coupling to an external apparatus via the network 300 or the like. The network interface 104 can be, for example, a network interface card (NIC).

The disk interface 105 is an interface for coupling to the HDD 103 or an external apparatus. The disk interface 105 can be, for example, a host bus adapter (HBA).

The input/output interface 106 is an interface for inputting various types of data to the management server 100 and for outputting various types of data. The input/output interface 106 includes some combination of a keyboard, a mouse, a touch panel, a display, and the like. The management server 100 may not have the input/output interface 106. Input to and output from the management server 100 in this case can be conducted over a network with the use of a Secure Shell (SSH), for example.

FIG. 5 is an explanatory diagram illustrating an example of the configuration of the storage apparatus 200 according to the first embodiment.

The storage apparatus 200 includes a management interface 201, an external interface 202, a controller unit 220, a disk unit 230, and a disk interface 240.

The management interface 201 is an interface for coupling to the management server 100 via the management-use network. The external interface 202 is an interface for coupling via the business operation-use network, to the physical servers 150 which are provided with a storage area such as the volumes 210 by the storage apparatus 200. In the case where no distinction is made between the management-use network and the business operation-use network, the management interface 201 and the external interface 202 may be integrated into a single interface.

The controller unit 220 exerts various types of control on the storage apparatus 200. The controller unit 220 includes a control apparatus 221 and a memory 222. The control apparatus 221 controls access to the volumes 210 and other storage areas, namely, I/O. The control apparatus 221 also controls the storage area configuration in the disk unit 230. The memory 222 is used as a control area and a cache of I/O.

The disk unit 230 includes a plurality of HDDs 231 installed therein. Other storage media than HDDs may be installed in the disk unit 230. In the first embodiment, the controller unit 220 generates as the volumes 210 logical storage areas that are given redundancy with the use of the plurality of HDDs 231 installed in the disk unit 230, and provides the volumes 210 to the physical servers 150. The controller unit 220 manages the association between the volumes 210 and the HDDs 231.

Methods that are commonly used to give redundancy with the use of the plurality of HDDs 231 include Redundant Arrays of Inexpensive Disks (RAID) and Redundant Arrays of Inexpensive Nodes (RAIN).

The disk interface 240 is an interface for communication between the control unit 220 and the disk unit 230.

The storage apparatus 200 which is implemented by a dedicated apparatus in the first embodiment may be implemented by one or more computers (for example, the physical servers 150). In this case, the control apparatus 221 corresponds to the CPU 101, the memory 222 corresponds to the memory 102, the external interface 202 corresponds to the network interface 104, and the HDDs 231 correspond to the HDD 103.

The controller unit 220 may have a function of guaranteeing or restricting, for each volume 210, access to the volume 210 in the form of Input Output per Second (IOPS) or the like.

The storage apparatus 200 may include an SSD which is fast in I/O and an HDD which is slow in I/O to build the volumes 210 from the HDD and the SSD. The controller unit 220 in this case may have a function of dynamically changing I/O performance (a dynamic tiering function) by changing the ratio of the storage area of the HDD and the storage area of the SSD that construct the volumes 210.

FIG. 6 is an explanatory diagram showing an example of the physical server management information T100 according to the first embodiment.

The physical server management information T100 stores, for each physical server 150, information (a record) for managing the physical configuration of the physical server 150. Specifically, the physical server management information T100 includes in each record a server ID (T110), a physical CPU number (T120), a CPU frequency (T130), a memory capacity (T140), and a hypervisor/OS (T150).

The server ID (T110) is an identifier for uniquely identifying one physical server 150. The physical CPU number (T120) is the number of the CPUs 101 that the physical server 150 has. The CPU frequency (T130) is the frequency of the CPUs 101 of the physical server 150. The memory capacity (T140) is the total capacity of the memory 102 that the physical server 150 has.

The hypervisor/OS (T150) indicates the type of software that controls the physical server 150, namely, whether the software is the hypervisor 400 or an OS.

The physical server management information T100 may include the type of the network interface 104, a communication band, the type or part number of the HDD 103, and the like. Information of higher granularity such as the number of sockets that the physical server 150 has or the CPU core number per socket may be stored as the physical CPU number (T120).

It is common in cloud services to give the physical servers 150 that are for the business operation use the same configuration, in view of the operation management cost or the like. The physical server management information T100 of FIG. 6 therefore stores information that corresponds to the general configuration of the cloud service 1200. However, this invention is also applicable to a heterogeneous configuration in which the configuration of one physical server 150 differs from that of another.

FIG. 7 is an explanatory diagram showing an example of the storage management information T200 according to the first embodiment.

The storage management information T200 stores information (a record) for managing the storage area of the storage apparatus 200. Specifically, the storage management information T200 includes in each record a storage apparatus ID (T210), a volume ID (T220), a capacity (T230), and IOPS (T240).

The storage apparatus ID (T210) is an identifier for uniquely identifying one storage apparatus 200. The volume ID (T220) is an identifier for uniquely identifying the volume 210 that is provided by the storage apparatus 200. The capacity (T230) is the capacity of the volume 210. The IOPS (T240) is the IOPS of the volume 210.

The column for the IOPS (T240) is included in the case where the storage apparatus 200 has a function of guaranteeing or restricting a given IOPS for each volume 210. A premise of the description given here is that the first embodiment has a configuration in which the IOPS value can be specified.

In the case where the storage apparatus 200 has the dynamic tiering function, the storage management information T200 may include a column for storing the performance of the dynamic tiering function. The column for the IOPS (T240) described above may store, for each volume 210, values “high”, “intermediate”, and “low”, for example, as a performance indicator, or may store a value indicating the composition ratio of the HDD and the SSD that construct the volume 210, or may store an IOPS value that is estimated from the HDD-SSD composition ratio or from other parameters.

The storage management information T200 may also include, for each volume 210, the consumed capacity of the volume 210, the capacity of a cache set to the volume 210, and the like.

FIG. 8 is an explanatory diagram showing an example of the virtual-physical configuration management information T300 according to the first embodiment.

The virtual-physical configuration management information T300 stores, for each VM 410, information (a record) for managing computer resources of the VM 410, the physical placement of the VM 410, and the like. Specifically, the virtual-physical configuration management information T300 includes in each record a VM ID (T310), virtual resources (T320), and physical resources (T330).

The VM ID (T310) is (T310) is an identifier for identifying one VM 410 uniquely throughout the computer system. The virtual resources (T320) are information about virtual computer resources that are allocated to the VM 410. The physical resources (T330) are information about the physical placement of the VM 410. Concrete information of the virtual resources (T320) and concrete information of the physical resources (T330) are described below.

The virtual resources (T320) include a CPU number (T321), a memory capacity (T322), IOPS (T323), a CPU share (T324), a memory share (T325), and an I/O share (T326).

The CPU number (T321) is the number of virtual CPUs allocated to the VM 410. The memory capacity (T322) is the capacity of a virtual memory allocated to the VM 410.

The IOPS (T323) is the IOPS value of the volume 210 that is allocated to the VM 410. In the case where the VM 410 or the hypervisor 400 does not have a function of guaranteeing or restricting I/O to and from the storage apparatus 200, the virtual-physical configuration management information T300 may not include the IOPS (T323).

The CPU share (T324), the memory share (T325), and the I/O share (T326) indicate the degrees of sharing of computer resources among the plurality of VMs 410 running on the same physical server 150. The values of the columns for T324, T325, and T326 are set by the hypervisor 400 by following an instruction from the management server 100 when the relevant tenant 1400 is built, and are changed suitably while the tenant 1400 is in operation.

One of the features of the server virtualization technology is a function called over-provisioning. Over-provisioning is a function of allocating to each VM 410 more computer resources than those possessed by a single physical server 150. In other words, over-provisioning allows the computer system to set a plurality of VMs 410 running on the same physical server 150 so that the sum of CPU numbers (T321) allocated to the respective VMs 410 exceed the number of the CPUs 101 that the physical server 150 has, or so that the sum of memory capacities (T322) allocated to the respective VMs 410 exceeds the memory capacity that the physical server 150 has.

In the case of a server that has “Serv1” as the server ID (T110), for example, each VM 410 can be allocated a memory capacity in a manner that satisfies Expression (1).

(Sum of Memory Capacities (T322) of VMs Operating on Serv1)>(Memory Capacity (T140) of Serv1) (1)

In the physical server 150 that has the over-provisioning function, computer resources that this physical server 150 has are shared by a plurality of VMs 410. Therefore, in a case where all VMs 410 that run on the same physical server 150 respectively use their allocated virtual CPUs and allocated virtual memories fully, indicators that determine the computer resource allocation of the VMs 410 sharing the computer resources are stored as the CPU share (T324), the memory share (T325), and the I/O share (T326).

The CPU share (T324), the memory share (T325), and the I/O share (T326) in the first embodiment each have one of the values “high”, “intermediate”, and “low”. In the case where “high” is set as the memory share (T325) for one VM 410, for example, the hypervisor 400 allocates a memory space preferentially to this VM 410 out of a plurality of VMs 410 sharing computer resources.

The CPU share (T324) and the memory share (T325) may have a value “exclusive”. In this case, the VM 410 for which “exclusive” is set is always allocated computer resources that are set in the relevant columns such as the column for the CPU number (T321). This guarantees that necessary computer resources are allocated to the given VM 410. A response time per I/O may be set as the IOPS (T326).

Numerical values that indicate the degrees of sharing may be set as the CPU share (T324), the memory share (T325), and the I/O share (T326).

The virtual resources (T320) may include, in addition to the columns described above, columns for a reserved value and a limit value with respect to CPU number (reserved CPU number and limit CPU number), and columns for a reserved value and a limit value with respect to memory capacity (reserved memory capacity and limit memory capacity). Columns for a reserved value and a limit value with respect to CPU frequency (reserved CPU frequency and limit CPU frequency) may be included in addition to the reserved CPU number column and the limit CPU number column.

A reserved value set for one VM 410 is a value indicating the quantity of a computer resource that is always guaranteed to be allocated to the VM 410. A limit value set for one VM 410 is a value indicating an upper limit to the quantity of a computer resource that can be allocated to the VM 410.

For example, in the case of the VM 410 whose memory capacity (T322) is “4 GB”, reserved memory capacity is “1 GB”, and limit memory capacity is “2 GB”, the memory capacity of a virtual memory that is recognized by the VM 410 is 4 GB, of which 1 GB is always secured for the VM 410 from the memory space of the relevant physical server 150, and the maximum memory space of the physical server 150 that the VM 410 is allowed to use is 2 GB.

The physical resources (T330) are described next. The physical resources (T330) include a server ID (T331) and a volume ID (T332).

The server ID (T331) is the same as the server ID (T110). The management server 100 can know, from the server ID (T331), on which physical server 150 the VM 410 in question is currently running.

The volume ID (T332) is the same as the volume ID (T220). The management server 100 can know, from the volume ID (T332), which volume 210 stores management data and the like of the VM 410 in question and which storage apparatus 200 provides this volume 210.

In the first embodiment, where each volume 210 can be identified uniquely from the identifier of the volume 210, the physical resources (T330) include only the volume ID (T332). In the case where each volume 210 can be identified uniquely from the identifier of the volume 210 and the identifier of the storage apparatus 200, the physical resources (T330) may include a column that corresponds to the storage apparatus ID (T210), in addition to the column for storing the identifiers of the volumes 201.

Each VM 410 in the first embodiment is provided with a storage area so that a storage area (drive) recognized by the VM 410 is associated with one volume 210 on a one-to-one basis. On the other hand, in the case of a configuration where a storage area is specified for one VM 410 in units of drive recognized by the VM 410, namely, a configuration in which one drive recognized by an OS that is executed on the VM 410 is associated with a plurality of volumes 210, the identifiers of the plurality of associated volumes 210 are stored as the volume ID (T332).

In the example of FIG. 8, data of a plurality of VMs 410 is stored in the same volume 210.

FIG. 9 is an explanatory diagram showing an example of the tenant management information T400 according to the first embodiment.

The tenant management information T400 stores information (a record) for managing each tenant 1400 that is provided to one of the users 1100 and the configuration of the tenant 1400. Specifically, the tenant management information T400 includes in each record a tenant ID (T410), a VM ID (T420), an IP address (T430), a function (T440), a coupling destination (T450), and a state (T460).

The tenant ID (T410) is the identifier of the tenant 1400 in question. The VM ID (T420) is the identifier of the VM 410 that is included in the tenant 1400, and is the same as the VM ID (T310).

The IP address (T430) is the IP address of the VM 410. An IP address stored as the IP address (T430) is an address that the VM 410 uses for communication to and from an external apparatus. A plurality of IP addresses may be stored as the IP address (T430) in one record.

The function (T440) indicates a function (service) that is provided by the VM 410, more specifically, a role fulfilled by software that is installed in the VM 410 or by other components. The role of the VM 410 is set when the service is signed up for or when the VM 410 is built.

The coupling destination (T450) is the IP address of another VM 410 with which the VM 410 that is identified by the VM ID (T420) holds communication. In a business operation system where different roles are distributed among a plurality of VMs 410, each VM 410 holds communication to and from another VM 410. The IP address of the VM 410 to which the VM 410 having the VM ID (T420) is coupled is therefore stored as the coupling destination (T450). In the case of the VM 410 that is coupled to a plurality of VMs 410, the record for this VM 410 stores a plurality of IP addresses as the coupling destination (T450).

The state (T460) indicates the state of the VM 410. A value indicating a state that is reached as a result of a change made by the resource optimizing program 3000 is stored as the state (T460) in the first embodiment. Specifically, one of values “scaled out”, “scaled in”, “scaled up”, and “scaled down” is stored. How the state (T460) is treated concretely is described in a description of processing that is executed by the resource optimizing program 3000.

A record in FIG. 9 where the tenant ID (T410) is “Tenant1” shows that the tenant 1400 in question is a three-tier Web system that includes five VMs 410.

The VM 410 that has “LB1” as the VM ID (T420) is the LB 1410 to which an IP address “10.0.0.1” is set and which serves as the front end. Two VMs 410 that have “VM11” and “VM12” as the VM ID (T420) are the Web servers 1420 which have a Web function of processing requests that are received from the LB. Two VMs 410 that have “VM13” and “VM14” as the VM ID (T420) are the DB servers 1430 which have a DB function of processing requests that are from the Web servers 1420.

The VM 410 that has a VM ID “VM 13” and the VM 410 that has a VM ID “VM14” construct a redundancy configuration (HA). The VM 410 that has a VM ID “VM13” is the primary (active) DB server 1430 which processes requests received from the Web servers 1420, and the VM 410 that has a VM ID “VM14” is the secondary (standby) DB server 1430.

An assumption of the first embodiment is that a record for the tenant 1400 of the user 1100 who signs up for a service is generated in the tenant management information T400 at the time of the sign-up. For example, in a case of signing up for a service, the user 1100 selects a business operation system configuration based on information that is stored in the system template management information T900, thereby causing a record for the tenant 1400 of the user 1100 to be added to the tenant management information T400. The VM ID (T420) and the IP address (T430) in the added record are set manually by the user 1100 or automatically when the tenant 1400 is built. The tenant management information T400 is updated as the need arises by processing that is executed by the resource optimizing program 3000 or by other components.

FIG. 10 is an explanatory diagram showing an example of the performance management information T500 according to the first embodiment.

The performance management information T500 stores, for each tenant 1400, history information (a record) about the performance of the tenant 1400. Specifically, the performance management information T500 includes, for each tenant 1400 that is associated with a tenant ID (T510), a time (T520), Web-consumed resources (T530), a total Web session number (T540), an SQL request number (T550), and primary DB-consumed resources (T560).

The tenant ID (T510) is the same as the tenant ID (T410). The time (T520) is a time at which values stored as the Web-consumed resources (T530), the total Web session number (T540), the SQL request number (T550), and the primary DB-consumed resources (T560) for the tenant 1400 that is identified by the tenant ID (T510), namely, information about the performance of this tenant 1400, has been obtained.

The Web-consumed resources (T530) indicate an average computer resource utilization ratio or an average computer resource usage in the Web servers 1420 that are included in the tenant 1400. The Web-consumed resources (T530) include a CPU utilization ratio (T531) and a memory utilization (T532).

The CPU utilization ratio (T531) and the memory utilization (T532) are an average utilization ratio of virtual CPUs allocated to the VMs 410 that are set as the Web servers 1420 and an average consumed capacity of virtual memories allocated to these VMs 410, respectively.

The total Web session number (T540) is the number of Web sessions managed by the Web servers 1420. The SQL request number (T550) is the number of requests transmitted from the Web servers 1420 to the active DB server 1430.

The primary DB-consumed resources (T560) indicate a computer resource utilization ratio or a computer resource usage in the primary DB server 1430 which actually processes requests received from the Web servers 1420. The primary DB-consumed resources (T560) include a CPU utilization ratio (T561), a memory utilization (T562), and IOPS (T563).

The CPU utilization ratio (T561) and the memory utilization (T562) are the utilization ratio of a virtual CPU allocated to the VM 410 that is set as the primary DB server 1430 and the consumed capacity of a virtual memory that is allocated to this VM 410, respectively. The IOPS (T563) is the IOPS to/from the relevant volume 210.

The primary DB-consumed resources (T560) may include a column for managing the performance state of the primary DB server 1430 which includes performance failure events and other states.

The management server 100 manages the performance of the VMs 410 and other components of each tenant 1400 based on the tenant management information T400 and the performance management information T500.

For example, FIG. 10 shows history information of the performance of the tenant 1400 that has “Tenant1” as the tenant ID (T510). The management server 100 finds out from the history information that, when the time (T520) is “9:00”, the two Web servers 1420 which are the VMs 410 having VM IDs “VM11” and “VM12” have an average CPU utilization ratio of 30%, an average memory utilization of 1 GB, and a Web session number of 10. The management server 100 also knows from the history information that the number of SQL requests that are transmitted from the VMs 410 having VM IDs “VM11” and “VM12” to the active DB server 1430, namely, the VMs 410 having VM IDs “VM13” and “VM14”, is 20.

The history information of the performance of the tenant 1400 that has a tenant ID “Tenant1” also tells the management server 100 that the load increases with time.

How to use the primary DB-consumed resources (T560) is described in the description of processing that is executed by the resource optimizing program 3000 or by other components.

The performance management information T500 is generated by, for example, the configuration/performance management program 2200. Specifically, the configuration/performance management program 2200 obtains information of the respective components from the hypervisor 400 of the physical server 150 or others, and adds information to the performance management information T500 based on the obtained information.

While the performance management information T500 stores for each tenant 1400 information that is a compilation of data about the performance of components of the tenant 1400, this invention is not limited thereto. For example, the performance management information T500 may store, in time series, performance information of each VM 410 included in the tenant 1400. The management server 100 in this case calculates various types of information such as the CPU utilization ratio (T531) of FIG. 10 by compiling pieces of performance information of the respective VMs 410 for the performance management information T500 in response to a request from the outside.

FIG. 11 is an explanatory diagram showing an example of the system template management information T900 according to the first embodiment.

The system template management information T900 stores information (a record) about a business operation system configuration that is requested by the user 1100, namely, a system template. Specifically, the system template management information T900 includes in each record a pattern ID (T910), a Web server (T920), a DB server (T930), and a Tbl ID (T940).

Conceptually, a column for the Web server (T920) is for registering a server that can be scaled out, and a column for the DB server (T930) is for registering a server that is coupled to a server capable of scaling out and that needs to be scaled up.

The pattern ID (T910) is an identifier for uniquely identifying a system template that is managed in the system template management information T900.

The Web server (T920) is information that indicates the configuration of the Web servers 1420 in a business operation system that has the pattern ID (T910). The Web server (T920) includes an OS (T921), software (T922), a CPU number (T923), a memory capacity (T924), IOPS (T925), and an initial number (T926).

The OS (T921) indicates the name or type of an OS that is installed in the Web servers 1420. The software (T922) indicates the name or type of software that is installed in the Web servers 1420. The CPU number (T923), the memory capacity (T924), and the IOPS (T925) are information about specifications that are required of the Web servers 1420. The initial number (T926) is the number of the Web servers 1420 that are set in the business operation system.

The DB server (T930) is information that indicates the configuration of the DB servers 1430 in the business operation system that has the pattern ID (T910). The DB server (T930) includes an OS (T931), software (T932), a CPU number (T933), a memory capacity (T934), IOPS (T935), and a configuration (T936).

The OS (T931) indicates the name or type of an OS that is installed in the DB servers 1430. The software (T932) indicates the name or type of software that is installed in the DB servers 1430. The CPU number (T933), the memory capacity (T934), and the IOPS (T935) are information about specifications that are required of the DB servers 1430. The configuration (T936) is information indicating whether or not the DB servers 1430 are to construct the HA configuration, or other types of information. For example, a value “HA” stored as the configuration (T936) indicates that the DB servers 1430 have a redundancy configuration. A value “single” stored as the configuration (T936), on the other hand, indicates that no DB servers construct a redundancy configuration.

The Tbl ID (T940) is the identifier of a record of the resource changing method management information T800, which is described later. The Tbl ID (T940) specifies a computer resource changing method that is to be applied to the business operation system.

The system template management information T900 may include a link for information such as a script that is used by the configuration changing program 2300 to build the business operation system.

While the system template management information T900 includes the columns for the Web servers 1420 and the DB servers 1430 in the first embodiment, which is premised that a business operation system is a three-tier Web system, this invention is not limited thereto. The system template management information T900 may be information for managing business operation systems that are not three-tier Web systems.

FIG. 12 is an explanatory diagram showing an example of the customer management information T600 according to the first embodiment.

The customer management information T600 stores, for each user 1100 who is a customer, information (a record) for managing the tenant 1400 that is used by the user 1100. Specifically, the customer management information T600 includes in each record a user ID (T610), a tenant ID (T620), a type (T630), and a pattern ID (T640).

The user ID (T610) is an identifier for identifying the user 1100 who uses the cloud service 1200. The tenant ID (T620) is an identifier for identifying the tenant 1400 that the user 1100 uses, and is the same as the tenant ID (T410).

The type (T630) is information that indicates the type of a contract mode regarding a performance guarantee and the like of the tenant 1400. One of values “guaranteed performance type”, “fixed performance type”, and “best effort type” is stored as the type (T630) in the first embodiment.

The “guaranteed performance type” contract mode guarantees that the performance of the tenant 1400 is equal to or more than a given standard. The “fixed performance type” contract mode guarantees that the tenant 1400 runs without deviating from a specified level of performance. The “best effort type” is a contract mode in which the user 1100 permits the performance of their own tenant 1400 to vary depending on the utilization situation of the tenants 1400 and the like of other users 1100. The tenants 1400 managed in the first embodiment are of the “guaranteed performance type”.

Instead of the information indicating the mode of contract, information about scaling may be stored for each component of the tenant 1400 as the contract mode (T632), such as information indicating whether or not the scale of the Web servers 1420 can be changed and information indicating whether or not the scale of the DB servers 1430 can be changed.

The pattern ID (T640) is the identifier of a system template that is specified when the tenant 1400 is built, and is the same as the pattern ID (T910).

The customer management information T600 is generated by the customer management program 2500 when the user 1100 signs up for a service, or other times, and is updated by the customer management program 2500. In the case where the customer management program 2500 cooperates with the charging program 2400, the customer management information T600 may include charging information or information that is used in charging a fee.

FIG. 13 is an explanatory diagram showing an example of the scale management information T700 according to the first embodiment.

The scale management information T700 stores, for each three-tier Web system that has the “guaranteed performance type” contract mode, information (a record) that indicates a relation between the number of the Web servers 1420 and computer resources to be allocated to each DB server 1430 in the three-tier Web system. Specifically, the scale management information T700 includes in each record a pattern ID (T710), a Web server number (T720), and a DB server (T730).

The pattern ID (T710) is an identifier for uniquely identifying a system template, and is the same as the pattern ID (T910). The Web server number (T720) is the number of the Web servers 1420 included in a business operation system that is associated with the system template having the pattern ID (T710).

The DB server (T730) is information about computer resources of the DB server 1430 that are necessary for the business operation system depending on the number of the Web servers 1420, and includes a CPU number (T731), a memory capacity (T732), and IOPS (T733). The DB server (T730) may additionally include a column for the frequency of a CPU and other columns.

The DB server (T730) also includes a limit SQL request number (T734). The limit SQL request number (T734) is the number of SQL requests that can be processed by the DB server 1430 whose computer resources (specifications) are as indicated by the values of the CPU number (T731), the memory capacity (T732), and the IOPS (T733). The limit SQL request number (T734) in the first embodiment is used as an indicator for determining the load on the DB server 1430.

Instead of the limit SQL request number (T734), an upper limit to the CPU utilization ratio, to the memory utilization, or to the IOPS, or a list of performance failure events, or the like may be stored in the scale management information T700 as an indicator for determining the load on the DB server 1430.

Values stored in the scale management information T700 may be ones that are defined for each system in advance, or ones that are determined by evaluating the performance of the tenant 1400 in question when the tenant 1400 is built.

In a three-tier Web system, the number of the Web servers 1420 increases or decreases dynamically depending on the load on the system. The scale management information T700 is used to determine computer resources necessary for the system's DB server 1430 in the wake of a change made to the number of the Web servers 1420 by an addition or a removal.

For example, in a case where a three-tier Web system includes two Web servers 1420, the management server 100 refers to the scale management information T700 to find out that computer resources necessary for the system's DB server 1430 are two CPUs, 5 gigabytes of memory capacity, and 300 IOPS.

The management server 100 in the first embodiment refers to the scale management information T700 to allocate the DB server 1430 computer resources enough to process requests in Web sessions that are managed by the Web servers 1420. A failure to process SQL requests transmitted from the Web servers 1420 due to a lack of processing performance of the DB server 1430, and other similar failures, can be avoided in this manner.

As the method of determining computer resources that are to be allocated to the DB server 1430, the management server 100 may calculate the computer resources dynamically based on the virtual-physical configuration management information T300 and the performance management information T500, instead of using table-format information such as the scale management information T700.

An example of the alternative method is to use a function or the like that calculates computer resources necessary for the DB server 1430 by inputting the number of the Web servers 1420 or the number of SQL requests. In another example, the management server 100 determines necessary computer resources by profiling computer resources of the Web server 1420 that are necessary to process SQL requests based on an increase/decrease in SQL request number (T550), and on history information about the CPU utilization ratio, memory utilization, and IOPS value of the DB server 1430. In this case, the performance management information T500 needs to store the CPU utilization ratio, memory utilization, and the like of the DB server 1430.

FIG. 14 is an explanatory diagram showing an example of the resource changing method management information T800 according to the first embodiment.

The resource changing method management information T800 stores management information (a record) of changing methods that are used in a case where the resource optimizing program 3000 changes computer resource allocation of the VMs 410. Specifically, the resource changing method management information T800 includes in each record a Tbl ID (T810), a target (T820), a changing method (T830), and a classification (T840).

The method of changing computer resources that can be applied varies from one combination of an OS and software to another. It is therefore necessary to compile, in advance, for each type of computer resource that is a target of change, changing methods that can be applied to the target computer resource, in association with information that indicates the impacts of the application of the changing methods on a business operation system.

The management server 100 in the first embodiment therefore uses the resource changing method management information T800 to manage a group of a plurality of computer resource changing methods for change target computer resources as a changing method (record) to be applied to one business operation system.

In some cases, the method of changing computer resources that can be applied varies depending also on the hypervisor type. The resource changing method management information T800 in this case stores information that takes into consideration the combination of an OS, software, and a hypervisor as well.

The Tbl ID (T810) is an identifier for uniquely identifying a record of the resource changing method management information T800. The target (T820) indicates the type of a computer resource that is a target of change.

The changing method (T830) indicates the specifics of control that is executed to change the allocation of the change target computer resource. While the specifics of control are stored as the changing method (T830) in the example of FIG. 14, a command or script for instructing the configuration changing program 2300 to execute changing processing may be stored instead. An execution order in which changing methods are executed or priority levels for determining the execution order, or information about changing methods that are mutually exclusive, or other types of information may be stored as the changing method (T830).

The classification (T840) is information that indicates an impact on a VM, or on an OS or software running on the VM, which results from applying a changing method that is indicated by the changing method (T830). Information indicating whether or not the relevant VM 410 is shut down by the application of the changing method in question is stored as the classification (T840) in the first embodiment. A value “no shutdown” of the classification (T840) indicates that the VM 410 to which the changing method is applied does not shut down, namely, that the impact on a business operation system is small. A value “shutdown” of the classification (T840) indicates that the VM 410 to which the changing method is applied shuts down, namely, that the impact on a business operation system is large.

The management server 100 can manage the respective changing methods based on the resource changing method management information T800. For example, the resource changing method management information T800 tells the management server 100 that a changing method that has “CPU” as the target (T820), “changing the CPU share value” as the changing method (T830), and “no shutdown” as the classification (T840) can change the CPU share value with respect to the relevant VM 410 without shutting down this VM 410.

Some combinations of the hypervisor 400, an OS, and software have a function that is called hot-add and that allows for an addition of a component while the system is running and, in some combinations of software where this function is available, changing the CPU number or other parameters can be executed as a changing method without “shutdown”.

Changing methods managed for each Tbl ID (T810) are determined based on components of a business operation system. While a premise of the first embodiment is the virtualization technology, physical servers may instead be the target of change. In this case, making changes with respect to the external storage apparatus and other similar methods out of the changing methods of FIG. 14 can be applied. This invention is accordingly effective not only for computer systems compatible with the virtualization technology but also for computer systems incompatible with the virtualization technology, namely, business operation systems that are built from the physical servers 150 themselves.

In the following description, a changing method that has “no shutdown” as the classification (T840) may be referred to as “changing method without shutdown”, and a changing method that has “shutdown” as the classification (T840) may be referred to as “changing method with shutdown”.

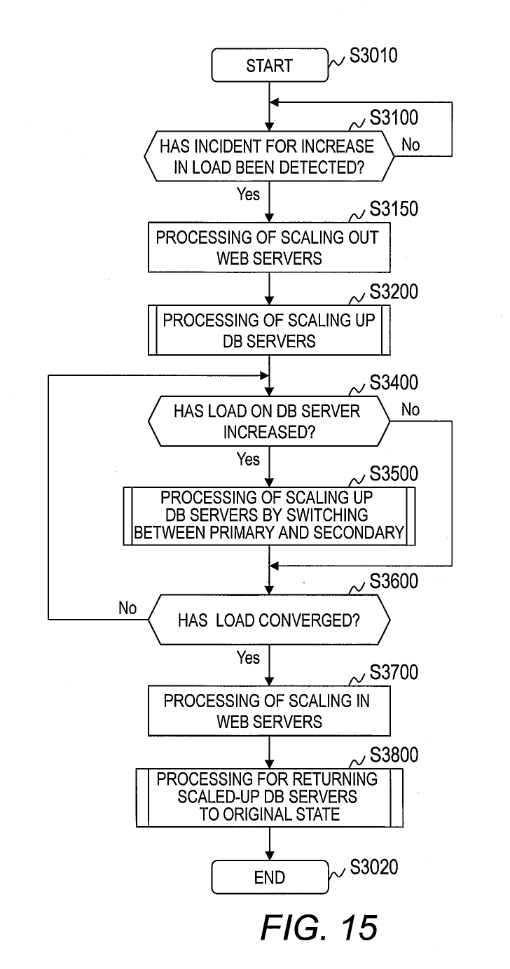

FIG. 15 is a flow chart outlining processing that is executed by the resource optimizing program 3000 of the first embodiment.

A given trigger starts the processing of the resource optimizing program 3000 (Step S3010).

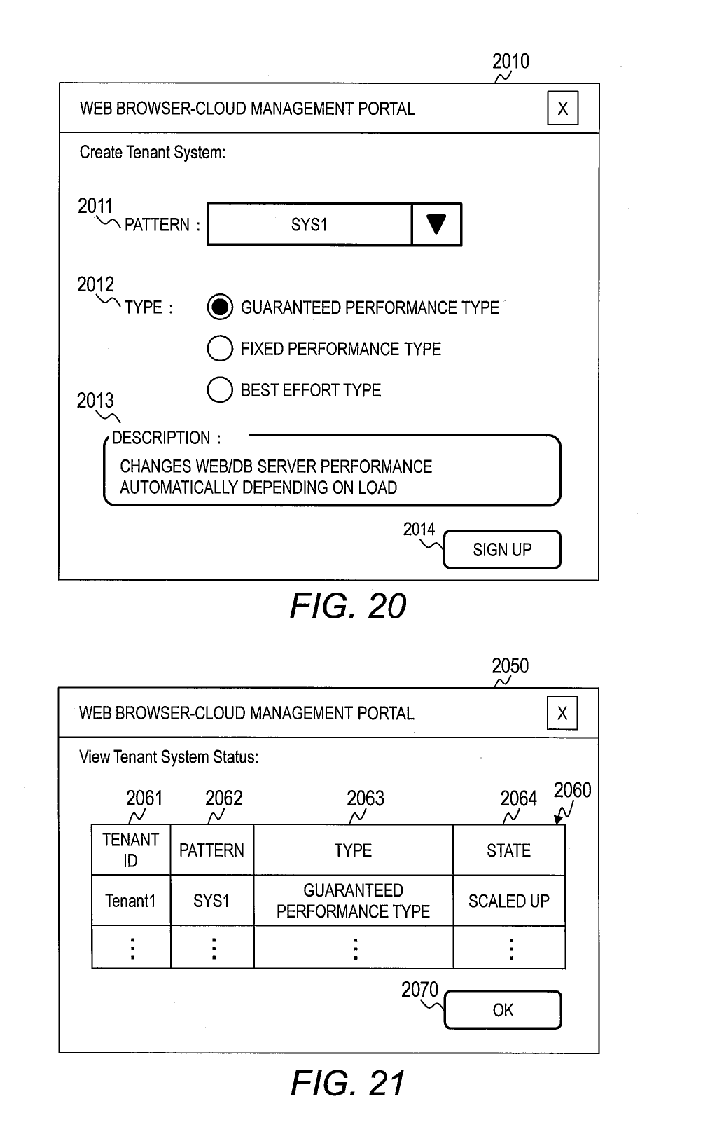

For example, the resource optimizing program 3000 starts the processing after the tenant 1400 of one user 1100 is built. More specifically, the processing is started after the user 1100 signs up for a service with the use of a screen illustrated in FIG. 20 to build the tenant 1400, and the configuration changing program 2300 builds a business operation system (the tenant 1400) based on the service that the user 1100 has signed up for.

The assumption here is that a business operation system for which this processing is performed is a business operation system for which executing scaling out or scaling up is set at the time of signing up for a service.

The screen used to sign up for a service is described with reference to FIG. 20. FIG. 20 is an explanatory diagram illustrating an example of the screen that is used to sign up for a service in the first embodiment.

The screen of FIG. 20 which is denoted by 2010 is displayed when the user 1100 accesses the portal 2000 with the use of a Web browser, for example.

The screen 2010 includes a pattern input 2011, a type input 2012, a display item 2013, and a sign-up operation button 2014.

The pattern input 2011 is an input item for selecting the pattern of a business operation system (the tenant 1400) that the user 1100 desires. For example, values corresponding to the pattern ID (T910) of the system template management information T900 are displayed as the pattern input 2011.

The type input 2012 is an input item for specifying the performance characteristics of the business operation system. The type input 2012 corresponds to the type (T630) of the customer management information T600.

The display item 2013 is an item that outlines a service based on what has been input as the pattern input 2011 and the type input 2012. For example, an outline of the configuration of the business operation system, or components of the business operation system such as the Web server (T920) and the DB server (T930) are displayed as the display item 2013.

The sign-up operation button 2014 is a button that is operated when the user 1100 signs up for a service related to the business operation system that has been set by inputting values as the pattern input 2011 and the type input 2012. In the example of FIG. 20, the user 1100 signs up for a service of a business operation system that has a “guaranteed performance type” contract mode and a pattern “three-tier Web system 1”.

The screen 2010 may include an input item for specifying a behavior for each value of the function (T440) of the tenant management information T400, instead of the type input 2012. For example, the screen 2010 may include an input item for selecting whether or not the Web servers 1420 have a configuration that can be scaled out and scaled in, and an input item for selecting whether or not the DB servers 1430 have a configuration that can be scaled up and scaled down.

The screen 2010 may include an additional input item for selecting whether the scaling processing steps described above are to be executed automatically or at the discretion of the user 1100. Alternatively, the screen 2010 may be a screen for specifying the IP address and other items of the tenant management information T400 in addition to inputting the input items.

FIG. 20 has now been described and the description returns to FIG. 15.

The resource optimizing program 3000 refers to the performance management information T500 to determine whether or not an incident of an increase in load on the target tenant 1400 has been detected (Step S3100). The resource optimizing program 3000 refers to the performance management information T500 periodically. The load on the tenant 1400 means the overall load on the tenant 1400 or the load on the DB server 1430 that is included in the tenant 1400.

For example, the resource optimizing program 3000 determines whether or not the Web-consumed resources (T530), the total Web session number (T540), or other items in the performance management information T500 has a value that exceeds a given threshold. The resource optimizing program 3000 determines that an incident of an increase in load on the target tenant 1400 is detected in a case where the value of the Web-consumed resources (T530) or other items exceeds the given threshold.

An incident of an increase in load on the tenant 1400 may be detected by a method that uses, instead of the value of the Web-consumed resources (T530), the total Web session number (T540), or other items itself, the pace (speed) of increase of this value. Another way to detect an incident of an increase in load on the tenant 1400 is a method based on a metric that is commonly used in processing of determining whether the Web servers 1420 or other components are to be scaled out, such as the one described in JP 2012-99062 A.

The resource optimizing program 3000 may detect as an incident of an increase in load on the target tenant 1400 the fact that Step S3150 has been executed, namely, an event in which the scaling out of the Web servers 1420 is executed.

In the case where there is no incident of an increase in load on the target tenant 1400, the resource optimizing program 3000 returns to Step S3100 to execute the same processing repeatedly.

In the case where there is an incident of an increase in load on the target tenant 1400, the resource optimizing program 3000 executes processing of scaling out the Web servers 1420 (Step S3150).

The processing of scaling out the Web servers 1420 may be started based on the same standard that is used in Step S3100, or a standard that is set specially for automatic scaling. In the case where a starting standard set specially for automatic scaling is used, the processing of scaling out the Web servers 1420 is executed at the time when the resource optimizing program 3000 receives an event executed by the configuration changing program 2300.

The resource optimizing program 3000 may change the settings of the LB 1410 in conjunction with the processing of scaling out the Web servers 1420. For instance, the settings of the LB 1410 are changed so that requests to the Web server 1420 that is added by the scaling out are distributed. The settings of the LB 1410 can be changed by, for example, a method described in JP 2012-99062 A.

The added Web server 1420 may be a VM that is already in operation, or may be newly generated based on information of the Web servers 1420 that are used when the tenant is built.

After executing the processing of scaling out the Web servers 1420, the resource optimizing program 3000 executes processing of scaling up the DB servers 1430 (Step S3200).

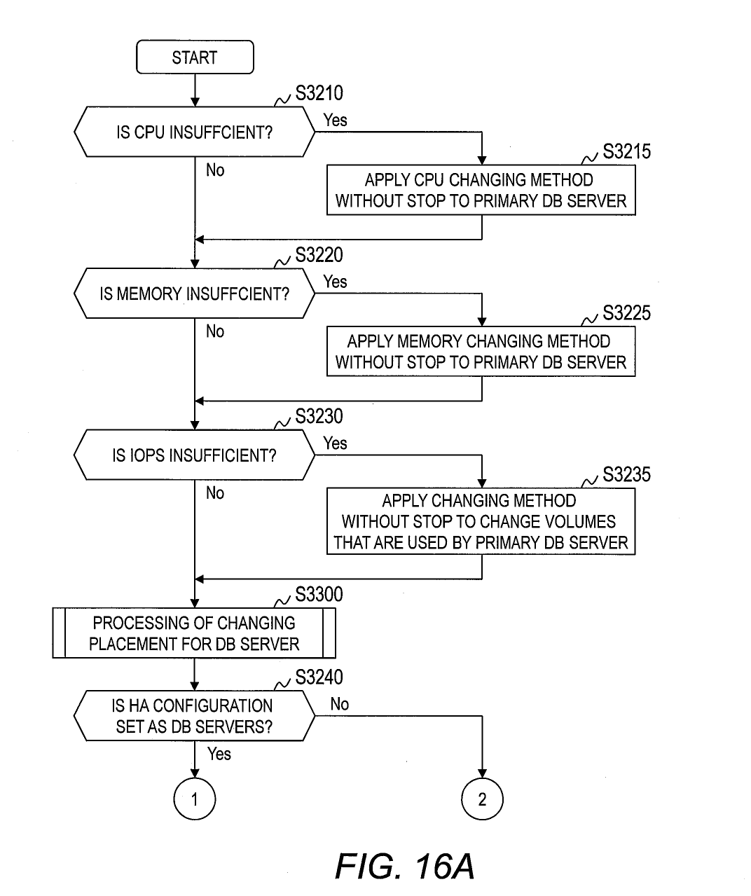

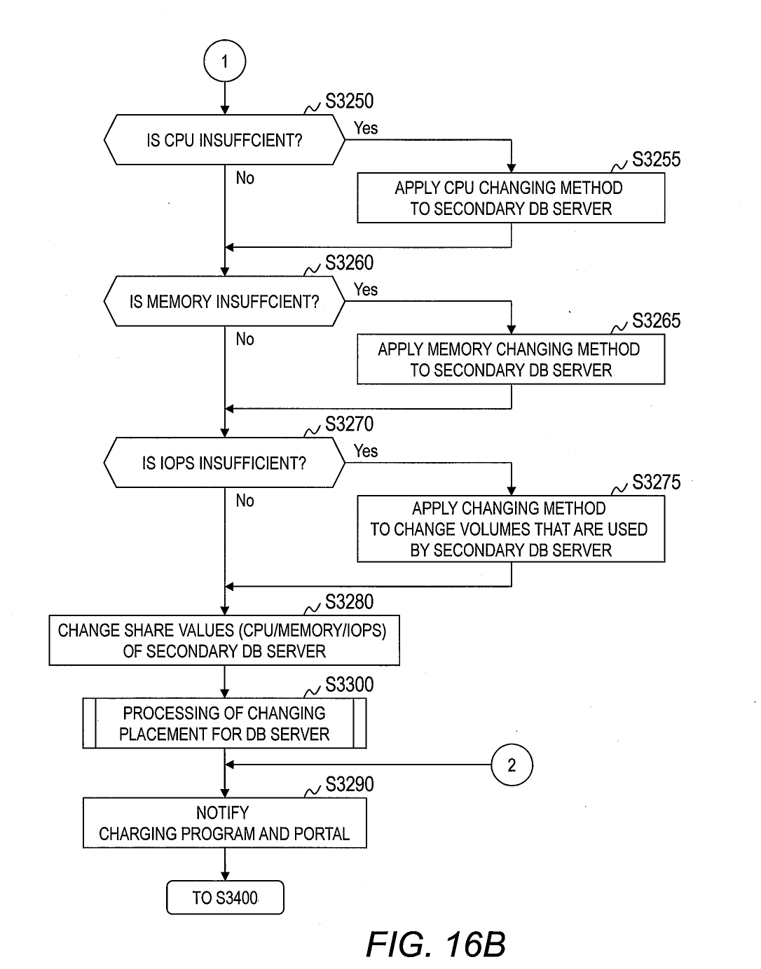

In Step S3200, the resource optimizing program 3000 scales up the primary DB server 1430 by applying a changing method that does not shut down the primary DB server 1430 to the primary DB server 1430. The resource optimizing program 3000 also scales up the secondary DB server 1430 by applying a changing method to the secondary DB server 1430. The changing method that is applied to the secondary DB server 1430 can be a changing method with shutdown or a changing method without shutdown. Details of Step S3200 are described later with reference to FIGS. 16A and 16B.

The resource optimizing program 3000 may determine, prior to Step S3200, whether it is necessary to increase the amount of computer resources such as virtual CPUs and virtual memories that are allocated to the DB servers 1430 to branch the processing of Step S3200 based on the result of the determination. For example, the resource optimizing program 3000 proceeds to Step S3200 in a case of determining that it is necessary to increase the amount of computer resources allocated to the DB servers 1430, and returns to Step S3100 in a case of determining that it is not necessary to increase the amount of computer resources allocated to the DB servers 1430.

The determination processing described above can be as follows. Specifically, the resource optimizing program 3000 receives as an input the numbers of the Web servers 1420 before and after the processing of scaling out the Web servers 1420 is executed, and refers to the scale management information T700 to determine whether or not it is necessary to increase the amount of computer resources of the DB servers 1430 based on the received numbers of the Web servers 1420.

For example, in the case where the number of the Web servers 1420 has changed from “1” to “2” by executing the processing of scaling out the Web servers 1420, the resource optimizing program 3000 determines that it is not necessary to increase the amount of computer resources allocated to the DB servers 1430. In the case where the number of the Web servers 1420 has changed from “2” to “3” by executing the processing of scaling out the Web servers 1420, the resource optimizing program 3000 determines that it is necessary to increase the amount of computer resources allocated to the DB servers 1430.

After executing the processing of scaling up the DB servers 1430, the resource optimizing program 3000 monitors the load on the active DB server 1430 and, based on the result of the monitoring, determines whether or not the load on the active DB server 1430 has increased (Step S3400).

The resource optimizing program 3000 determines whether or not the load on the DB server 1430 has increased based on, for example, the limit SQL request number (T734) of the scale management information T700. The resource optimizing program 3000 may use the CPU utilization ratio or the memory utilization instead of the limit SQL request number (T734) and, in the case where a performance failure event or the like is registered, may use the registered information as a condition for the determination.

A case where the number of the Web servers 1420 has changed from “2” to “3” in a three-tier Web system that has “SYS1” as the pattern ID (T710) is discussed as a concrete example. In this case, Step S3500 is executed if the number of SQL requests received by the active DB server 1430 exceeds the value “35” of the limit SQL request number (T734), which is the value in a case where the number of the Web servers 1420 is “2”, namely, before the processing of scaling out the Web servers 1420 is executed.

Step S3400 is provided because the switching, i.e., takeover processing, of the DB servers 1430 has a risk. This is because of a chance that some failure might occur during the switch between the DB servers 1430, and connection from the front end may become unstable during the switch between the DB servers 1430.

While the resource optimizing program 3000 in the first embodiment automatically executes Step S3500 in a case where an increase in load on the active DB server 1430 is detected, this invention is not limited thereto. For example, the resource optimizing program 3000 may notify the result of the determination in Step S3400 to an administrator (e.g., the user 1100) of the business operation system so that the administrator can determine whether to execute, or when to execute, Step S3500 or other types of processing. In this way, external factors that the program has no way of knowing, for example, business factors such as the launching of a provided service, can be taken into account.

In the case where the load on the active DB server 1430 has not increased, the resource optimizing program 3000 proceeds to Step S3600.

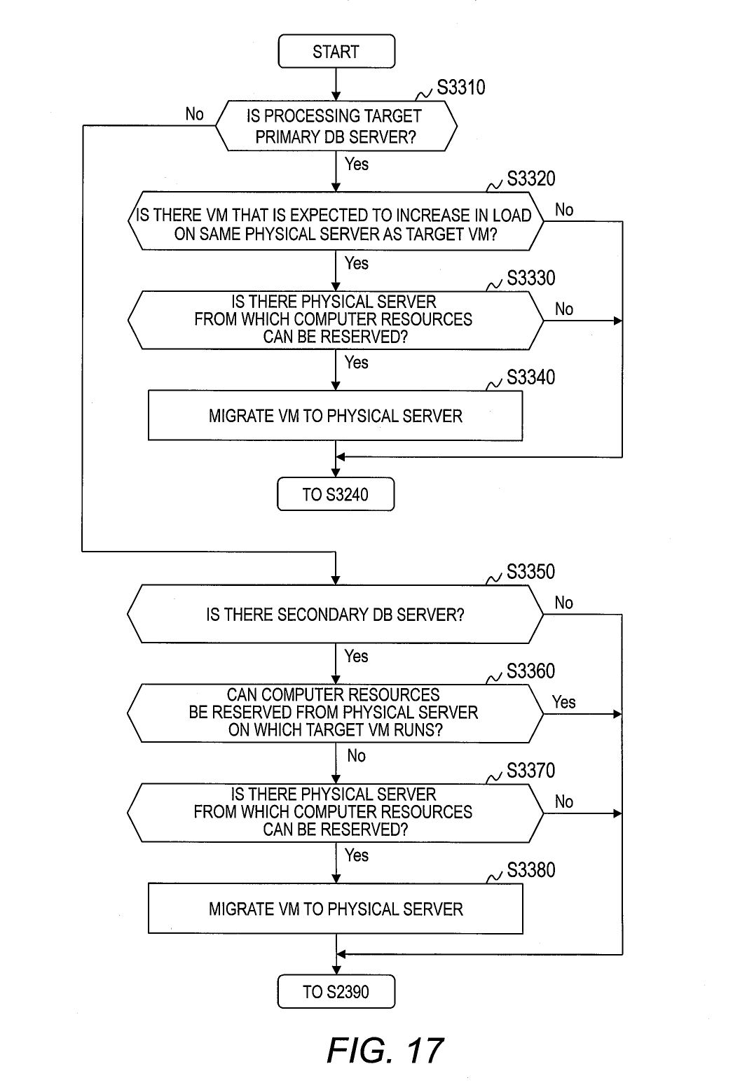

In the case where the load on the active DB server 1430 has increased, the resource optimizing program 3000 executes processing of scaling up the DB servers 1430 by switching between the primary DB server 1430 and the secondary DB server 1430 (Step S3500). Details of Step S3500 are described later with reference to FIG. 17.

When the result of the determination in Step S3400 is “no”, or after Step S3500 is executed, the resource optimizing program 3000 determines whether or not the load on the target tenant 1400 has converged (Step S3600).

In Step S3600, the resource optimizing program 3000 makes a determination based on the performance management information T500 as in Step S3100. For example, the resource optimizing program 3000 determines that the load on the target tenant 1400 has converged in a case where the value of the Web-consumed resources (T530) or the total Web session number (T540) is smaller than a given threshold.

The resource optimizing program 3000 may detect the fact that processing of scaling in the Web servers 1420 has been executed as the load on the target tenant 1400 has converged. The resource optimizing program 3000 may also determine that the load on the target tenant 1400 has converged in a case where the completion of a given event is detected. Alternatively, the resource optimizing program 3000 may determine that the load on the target tenant 1400 has converged in a case where a length of time set with the use of a timer elapses.

The resource optimizing program 3000 may take into account, as an additional condition, the maintaining of a state in which the value of the Web-consumed resources (T530) or the total Web session number (T540) is smaller than a threshold for a given period of time. In other words, the resource optimizing program 3000 determines that the load on the target tenant 1400 has converged in a case where convergent of the load is expected.

In the case where the load on the target tenant 1400 has not converged, the resource optimizing program 3000 returns to Step S3400 to execute the same processing.

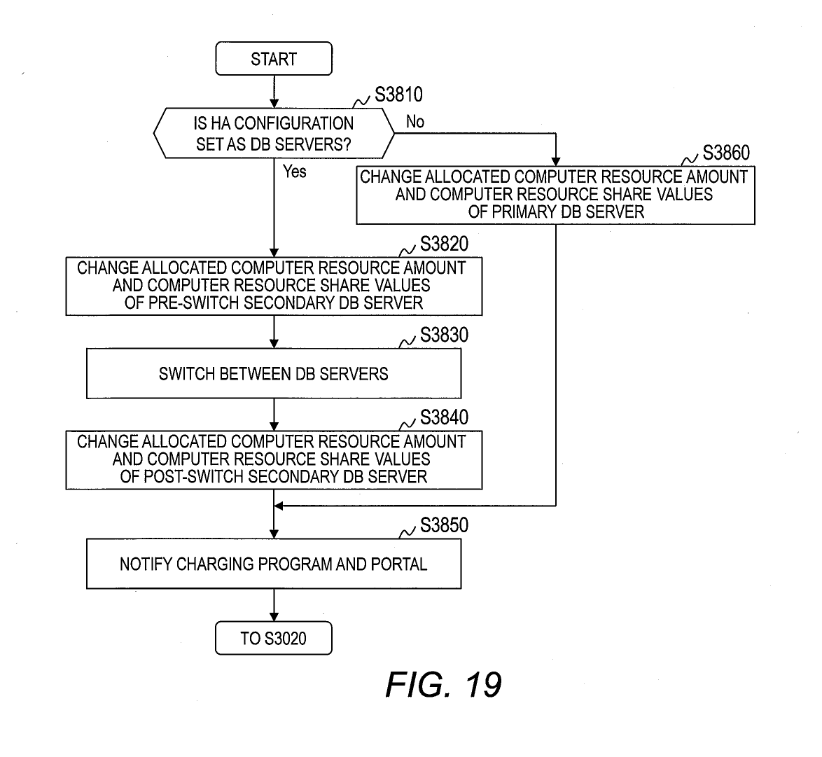

In the case where the load on the target tenant 1400 has converged, the resource optimizing program 3000 executes the processing of scaling in the Web servers 1420 (Step S3700). The processing of scaling in the Web servers 1420 can use a known technology. Thereafter, the resource optimizing program 3000 executes processing for returning the scaled up DB servers 1430 to the original state, namely, processing for scaling down the DB servers 1430 (Step S3800). Details of Step S3800 are described later with reference to FIG. 19.

The resource optimizing program 3000 ends all of the processing steps after Step S3800 is completed (Step S3020). The processing of the resource optimizing program 3000 which is ended after the completion of Step S3800 in the first embodiment may be loop processing in which the resource optimizing program 3000 returns after Step S3800 to Step S3010 to continue the processing. Shifts in the state of the tenant 1400 in the case of this loop processing are illustrated in FIG. 1.

The processing flow of FIG. 15 is not designed to deal with a case where a further incident of an increase in load on the tenant 1400 is detected while the processing of scaling up the DB servers 1430 is being executed in Step S3200. For instance, the processing flow of FIG. 15 cannot deal with a case where, after a change in the number of the Web servers 1420 from “2” to “3” starts the processing of scaling up the DB servers 1430, the number of the Web servers 1420 further changes from “3” to “4”.

The case described above can be dealt with by, for example, executing the processing of FIG. 15 recursively to scale up the DB servers 1430 in stages, and then scale down the DB servers 1430 in stages depending on the load situation.

FIGS. 16A and 16B are flow charts illustrating details of the processing of scaling up the DB servers 1430 which is executed in Step S3200 by the resource optimizing program 3000 of the first embodiment.

The resource optimizing program 3000 obtains information on the front end such as the amount of computer resources currently allocated to the active DB server 1430 and the current number of the Web servers 1420, and determines from the obtained information and from the scale management information T700 which computer resource is expected to become short.

For example, in a case where the number of the Web servers 1420 changes from “2” to “3”, the CPU number of the DB server 1430 is changed from “2” to “3”, and the memory capacity of the DB server 1430 is changed from “5 GB” to “7.5 GB”, and the IOPS of the DB server 1430 is changed from “300” to “600”. The resource optimizing program 3000 accordingly determines that there are a shortage of 1 in CPU number, a shortage of 2.5 GB in memory capacity, and a shortage of 300 in IOPS.

The resource optimizing program 3000 first determines whether or not there is a shortage of CPUs in the primary DB server 1430 (Step S3210). In a case of determining that there is no CPU shortage, the resource optimizing program 3000 proceeds to Step S3220.

In a case of determining that there is a shortage of CPUs, the resource optimizing program 3000 refers to the resource changing method management information T800 to apply a computer resource changing method that is related to CPUs to the primary DB server 1430 (Step S3215). Specifically, processing described below is executed.

The resource optimizing program 3000 searches the system template management information T900 for a record where the pattern ID (T910) matches the identifier of a system template that has been used in the building of the target tenant 1400. An identifier registered as the Tbl ID (T940) is obtained from the found record.

The resource optimizing program 3000 searches the resource changing method management information T800 for a record where the Tbl ID (T810) matches the obtained identifier. The resource optimizing program 3000 sequentially applies computer resource changing methods that are registered in the found record and that have “CPU” as the target (T820) and “no shutdown” as the classification “T840”.

For example, in the case where the changing method (T830) is “changing the CPU share value”, the resource optimizing program 3000 instructs the configuration changing program 2300 to change the CPU share value of the primary DB server 1430 to “high”. In the case where the changing method (T830) is “changing the CPU number”, the resource optimizing program 3000 instructs the configuration changing program 2300 to add as many CPUs as necessary to solve the shortage.

The resource optimizing program 3000 next determines whether or not there is a shortage of memories in the primary DB server 1430 (Step S3220). In a case of determining that there is no memory shortage, the resource optimizing program 3000 proceeds to Step S3230.

In a case of determining that there is a shortage of memories, the resource optimizing program 3000 refers to the resource changing method management information T800 to apply a computer resource changing method that is related to memories to the primary DB server 1430 (Step S3225).

Specifically, the resource optimizing program 3000 sequentially applies computer resource changing methods that are registered in the record found from the resource changing method management information T800 and that have “memory” as the target (T820) and “no shutdown” as the classification “T840”.

For example, in the case where the changing method (T830) is “changing memory share value”, the resource optimizing program 3000 instructs the configuration changing program 2300 to change the memory share value of the primary DB server 1430 to “high”. A computer resource changing method that has “changing the memory capacity” as the changing method (T830) needs to shut down the DB server 1430 to which the method is applied, and therefore is not applied in Step S3215.

The resource optimizing program 3000 next determines whether or not there is a shortage of IOPS in the primary DB server 1430 (Step S3230). In a case of determining that there is no IOPS shortage, the resource optimizing program 3000 proceeds to Step S3240.

In a case of determining that there is a shortage of IOPS, the resource optimizing program 3000 refers to the resource changing method management information T800 to apply a computer resource changing method to the primary DB server 1430 and the volume 210 that are used by the VM 410 that corresponds to the primary DB server 1430 (Step S3235).

Specifically, the resource optimizing program 3000 sequentially applies computer resource changing methods that are registered in the record found from the resource changing method management information T800 and that have “IOPS” as the target (T820) and “no shutdown” as the classification “T840”.

Changing the IOPS generally differs from changing CPUs and changing memories in that the relevant VM 410, or the hypervisor 400 on which the VM 410 runs, and the storage apparatus 200 can be set separately in most cases. The example of FIG. 14 gives “changing the limit value of IOPS on the hypervisor” and “changing the value of IOPS to/from the storage apparatus” as changing methods without shutdown.

In the case where the changing method (T830) is “changing the limit value of IOPS on the hypervisor”, the resource optimizing program 3000 checks whether or not a limit to the IOPS to/from the VM 410 that corresponds to the primary DB server 1430 is set to the relevant hypervisor 400 or to this VM 410. In the case where limit IOPS is set and the set upper limit to the IOPS is less than necessary IOPS, the resource optimizing program 3000 instructs the configuration changing program 2300 to relax the limitation on the IOPS.

For example, in a case where the current IOPS is less than necessary IOPS “600”, the resource optimizing program 3000 instructs the configuration changing program 2300 to set the IOPS to “600”.

In the case where the changing method (T830) is “changing the value of IOPS to/from the storage apparatus”, the resource optimizing program 3000 determines whether or not necessary IOPS can be secured with respect to the storage apparatus 200 and the volume 210 that are used by the VM 410 that corresponds to the primary DB server 1430. In a case of determining that necessary IOPS cannot be secured, the resource optimizing program 3000 instructs the configuration changing program 2300 to expand the IOPS.

Concrete processing is described with reference to FIG. 8. Here, the identifier of the VM 410 that corresponds to the primary DB server 1430 is “VM13”, and the IOPS is predicted to increase from “300” to “600”.

The resource optimizing program 3000 first calculates the total IOPS of the volume 210 that is used by the target VM 410, based on the virtual-physical configuration management information T300. The volume 210 that has “Vol2” as the volume ID (T332) is used by the VMs 410 that have identifiers “VM13” and “VM14”, and the total IOPS is therefore calculated as “600” in this case.

In a case where the IOPS of VM13 is predicted to increase from “300” to “600”, the total IOPS of the volume 210 that has the ID “Vol2” changes to “900”. On the other hand, a reference to a record of the storage management information T200 where the volume ID (T220) is “Vol2” reveals that the secured IOPS is “600”, which informs the resource optimizing program 3000 of an IOPS deficiency of “300”. The resource optimizing program 3000 accordingly instructs the configuration changing program 2300 to increase the IOPS of the volume 210 that has the ID “Vol2” by “300”, namely, to change the value of the IOPS (T240) to “900”.

In the case where the storage apparatus 200 has the dynamic tiering function, depending on the specified method, the resource optimizing program 3000 may instruct the configuration changing program 2300 to set the performance indicator to “high” or may instruct the configuration changing program 2300 to change the configuration of the volume 210 so that the composition ratio of the SSD is high.

While all computer resource changing methods that meet a condition out of compute resource changing methods that are registered in the resource changing method management information T800 are applied in Step S3215, Step S3225, and Step S3235, this invention is not limited thereto.

For example, in the case where a priority level indicating a place in application order is set to each computer resource changing method, the resource optimizing program 3000 may select one, or two or more changing methods based on the priority levels to execute the selected changing methods. In the case where an exclusive relation is further set between a plurality of computer resource changing methods, the resource optimizing program 3000 may apply one, or two or more computer resource changing methods based on the priority levels and the exclusive relation.

While the allocated computer resource amount is changed for each type of computer resource separately in Step S3215, Step S3225, and Step S3235, this invention is not limited thereto. For example, some cloud service 1200 defines, as types (also called flavors) of the VMs 410, a plurality of predetermined combinations of a CPU, a memory, and IOPS, and allows the user 1100 to change the performance, namely, allocated computer resource amount, of the active DB server 1430 by selecting one of the types.

In the cloud service 1200 of this kind, in a case where there is a shortage of one type of computer resource such as CPU or memory, processing equivalent to Step S3215, Step S3225, and Step S3235 is accomplished by executing processing suited to a VM type in which the type of computer resource that is in short can be secured. Setting a VM type that is determined by the number of the Web servers 1420 to the DB server (T730) of the scale management information T700 is also equivalent to executing Step S3215, Step S3225, and Step S3235.

While the processing is executed for CPUs, memories, and the IOPS in the order stated in the first embodiment, the processing order is not limited thereto. However, because of a correlation between memories and the IOPS in which a change in memory capacity causes a decrease in IO to/from the volume 210, the desirable processing order is to execute the processing for memories before the IOPS.

After changing the computer resources of the primary DB server 1430 (After Steps S3210 to S3235 are completed), the resource optimizing program 3000 executes processing of relocating the VM 410 that corresponds to the primary DB server 1430 (Step 3300). This is for securing more computer resources to be allocated to the primary DB server 1430. Details of Step S3300 are described later with reference to FIG. 17.

The resource optimizing program 3000 next determines whether or not there is the HA configuration built from the DB servers 1430 (Step S3240). In other words, whether or not there is the secondary DB server 1430 is determined.

The resource optimizing program 3000 can determine whether or not there is the HA configuration built from the DB servers 1430 based on, for example, the configuration (T936) of the system template management information T900, or the function (T440) of the tenant management information T400.

In a case of determining that there is no HA configuration built from the DB servers 1430, the resource optimizing program 3000 proceeds to Step S3290.

In a case of determining that there is the HA configuration built from the DB servers 1430, the resource optimizing program 3000 determines whether or not there are a CPU shortage, a memory shortage, and an IOPS deficiency separately in the secondary DB server 1430 (Step S3250, Step S3260, and Step S3270). The specifics of Step S3250, Step S3260, and Step S3270 are the same as those of Step S3210, Step S3220, and Step S3230. The difference is that the processing target is the secondary DB server 1430.

In the case of a CPU shortage or a memory capacity shortage, the resource optimizing program 3000 applies a computer resource changing method that is related to CPUs or memories to the secondary DB server 1430 (Step S3255 or Step S3265). The resource optimizing program 3000 also applies a computer resource changing method to the volume 210 that is used by the secondary DB server 1430 and the VM 410 that corresponds to the secondary DB server 1430 (Step S3275).

Step S3255 and Step S2365 are substantially the same as Step S3215 and Step S3225, except for the following points. Firstly, the processing target is the secondary DB server 1430. Secondly, changing methods with shutdown and changing methods without shutdown can both be applied in Step S3255 and Step S3265 whereas only changing methods without shutdown are applied in Step S3215 and Step S3225.

Step S3275 is substantially the same as Step S3235, except for the following point. The resource optimizing program 3000 does not apply a computer resource changing method in some HA configuration because, depending on how the HA configuration is configured, the primary DB server 1430 and the secondary DB server 1430 might share the same storage area (volume 210). The computer resource changing method that is applied can be a changing method with shutdown or a changing method without shutdown.

In the case where computer resources necessary to change the CPU number and the memory capacity cannot be secured in the physical server 150 on which the VM 410 corresponding to the DB server 1430 in question runs, the VM 410 is migrated to another physical server 150 that have computer resources available for allocation. The VM 410 can be migrated by the same method that is used in Step S3300, which is described later.

When the result of the determination in Step S3270 is “no”, or after Step S3275 is executed, the resource optimizing program 3000 changes the computer resource share values of the secondary DB server 1430 (Step S3280).

Specifically, the resource optimizing program 3000 decreases the computer resource share values of the secondary DB server 1430. This is because, whereas the primary DB server 1430 processes access from the Web servers 1420 before the execution of the takeover processing, there is no need after the takeover processing is executed to allocate many computer resources to the now secondary DB server 1430, which has been the primary DB server 1430 prior to the takeover processing.

The resource optimizing program 3000 therefore sets the actually allocated computer resource amount small by changing the share values, while scaling up CPUs, the memory capacity, and other computer resources that are recognizable to the VM 410 that corresponds to the secondary DB server 1430. This enables the hypervisor 400 to secure computer resources to be allocated to another VM 410 that runs on the same physical server 150. Computer resources are thus made the most of in the cloud service 1200 as a whole.

The resource optimizing program 3000 next executes processing of changing the resource placement for the secondary DB server 1430 (Step 3300). This is for securing more computer resources to be allocated to the secondary DB server 1430. Details of Step S3300 are described later with reference to FIG. 17.

When the result of the determination in Step S3240 is “no”, or after Step S3300 is executed, the resource optimizing program 3000 notifies changes made to the configuration of the target tenant 1400 to the charging program 2400 and the portal program 2100, and then proceeds to Step S3400.

The charging program 2400 receives from the resource optimizing program 3000 the changes made to the configuration of the tenant 1400, and charges the user 1100 of the tenant 1400 in accordance with a given charging system. The charging program 2400 may charge only a fee for the changed computer resources of the primary DB server 1430, or may charge a fee for the changed computer resources of the primary DB server 1430 and the secondary DB server 1430 both. The mode of charging is determined by the initial contract or a service menu that is provided by the entity that runs the cloud service 1200 in question.

FIG. 17 is a flow chart illustrating the processing of relocating the VMs 410 which is executed by the resource optimizing program 3000 of the first embodiment.

As described above with reference to FIGS. 16A and 16B, the processing of relocating the VMs 410 between one hypervisor 400 and another is executed in Step S3300 in order to set the share values in a manner that makes the most of computer resources.

The share values are indicators for distributing computer resources of one physical server 150 among a plurality of VMs 410. In the case where the share values of all the VMs 410 running on the hypervisor 400 of the physical server 150 are set to “high”, none of the VMs 410 can be allocated computer resources preferentially. In other words, efficient computer resource allocation is not accomplished despite setting the share values. Processing of relocating the VM 410 that corresponds to the primary DB server 1430 is executed in order to avoid this situation.

The share values of the VM 410 that corresponds to the secondary DB server 1430 are set to “low” before the takeover processing is executed. However, this VM 410 may use its allocated computer resources to the fullest extent in the future due to the takeover processing or the like. Therefore, in order to avoid a situation in which the computer resources allocated to the VM 410 cannot be secured fully, processing of relocating the VM 410 that corresponds to the secondary DB server 1430 is executed.

An example of technology for migrating one VM 410 between the hypervisors 400, i.e., between the physical servers 150, without shutting down the VM 410 is a vMotion function. The vMotion function is a technology that enables a VM to migrate, without shutting down, among a plurality of hypervisors where cluster settings are set in advance. With the use of this or a similar technology, the VM 410 can be migrated between the hypervisors 400 without shutting down the VM 410.

The share values, which are used as the determiners of a rate at which computer resources of one physical server 150 are distributed among the VMs 410 running on the same physical server 150, are also applicable to other components. For example, the share values may be applied to a cluster which includes a plurality of physical servers 150. The share values in this case are used as the determiners of a rate at which computer resources are distributed among the VMs 410 in the cluster, with the sum of computer resources of all physical servers 150 that are included in the cluster as the population parameter.

The resource optimizing program 3000 first determines whether or not the relocation processing that is about to be executed is for the VM 410 that corresponds to the primary DB server 1430 (Step S3310). For example, the resource optimizing program 3000 determines that the relocation processing is for the VM 410 that corresponds to the primary DB server 1430 in the case where this relocation processing is started after Step S3230 or Step S3235. In the following description, the VM 410 for which the relocation processing is executed may simply be referred to as target VM 410.

In a case of determining that the relocation processing is for the VM 410 that corresponds to the primary DB server 1430, the resource optimizing program 3000 determines whether or not an increase in load is expected for any of the other VMs 410 that run on the physical server 150 where the target VM 410 runs (Step S3320).

Specifically, the resource optimizing program 3000 searches the virtual-physical configuration management information T300 for records where the server ID (T331) matches the identifier of the physical server 150 on which the target VM 410 runs. A list of the other VMs 410 that run on the physical server 150 where the target VM 410 runs is obtained in this manner.

In each record found as a result of the search, the resource optimizing program 3000 refers to the values of the CPU share (T324), the memory share (T325), and the I/O share (T326) to determine whether or not there is the VM 410 that is expected to increase in load.

For example, the resource optimizing program 3000 focuses on a column in which the share value of the target VM 410 is to be raised, and determines whether or not there is the VM 410 for which “high” is set in this column. In a case of finding the VM 410 for which “high” is set in the column in question, the resource optimizing program 3000 determines that there is the VM 410 that is expected to increase in load.

The resource optimizing program 3000 may base the determination of Step S3320 on the state (T460) of the tenant management information T400. For example, the resource optimizing program 3000 determines that there is the VM 410 that is expected to increase in load in a case of finding a record in which “scaled up” is set as the state (T460) among other records than the record of the target VM 410.

The resource optimizing program 3000 may also base the determination of Step S3320 on the result of determination about whether or not the trend of increase in SQL requests is detected based on the SQL request number (T550) of the performance management information T500. The resource optimizing program 3000 determines that there is the VM 410 that is expected to increase in load in a case where the trend of increase in SQL requests is detected.

In a case of determining that there is no VM 410 that is expected to increase in load, the resource optimizing program 3000 proceeds to Step S3240 without executing any particular processing. This is because changing the share values to “high” does not affect the other VMs 410 and the migration of the VM 410 is unnecessary in this case.

In a case of determining that there is the VM 410 that is expected to increase in load, the resource optimizing program 3000 determines whether or not the physical server 150 from which computer resources necessary for the target VM 410 can be secured is found among the other physical servers 150 than the physical server 150 on which the target VM 410 runs (Step S3330).

In Step S3330, the same processing that is executed in Step S3320 is executed for each physical server 150. For example, the resource optimizing program 3000 refers to the virtual-physical configuration management information T300 for each physical server 150 to check, for every VM 410 running on the physical server 150, the value of a column of interest. In the case where “high” is set in the column of interest for none of the VMs 410 running on one physical server 150, the resource optimizing program 3000 determines this physical server 150 as the physical server 150 from which computer resources necessary for the DB server 1430 can be secured.

In a case where it is determined that there is no physical server 150 from which computer resources necessary for the DB server 1430 can be secured, the migration of the VM 410 is not feasible and the resource optimizing program 3000 accordingly proceeds to Step S3240 without executing any particular processing.

In a case of determining that there is the physical server 150 from which computer resources necessary for the DB server 1430 can be secured, the resource optimizing program 3000 uses an existing technology to migrate the target VM 410 from the physical server 150 on which the target VM 410 has been running to the found physical server 150, without shutting down the target VM 410 (Step S3340). Thereafter, the resource optimizing program 3000 proceeds to step S3240.

In a case where it is determined in Step S3310 that the relocation processing that is about to be executed is for the VM 410 that corresponds to the secondary DB server 1430, the resource optimizing program 3000 determines whether or not there is the secondary DB server 1430 (Step S3350). For example, the resource optimizing program 3000 refers to the state (T440) of the tenant management information T400 to determine whether or not the business operation system includes the secondary DB server 1430.

In a case of determining that the secondary DB server 1430 is not included in the business operation system, the resource optimizing program 3000 proceeds to Step S3290.

In a case of determining that there is the secondary DB server 1430, the resource optimizing program 3000 determines whether or not computer resources newly allocated by the execution of the scale-up processing can be secured from the physical server 150 on which the target VM 410 runs (Step S3360). Specifically, processing described below is executed.

The resource optimizing program 3000 searches the virtual-physical configuration management information T300 for records where the server ID (T331) matches the identifier of the physical server 150 on which the target VM 410 runs. The resource optimizing program 3000 refers to the found records to identify the VMs 410 for which “high” is set as the values of the columns for computer resources added after the execution of the scale-up processing, namely, the columns for the CPU share (T324), the memory share (T325), and the I/O share (T326).

The resource optimizing program 3000 calculates the total computer resource amount of the identified VMs 410 prior to the execution of the scale-up processing and the total computer resource amount of the identified VMs 410 after the execution of the scale-up processing. The resource optimizing program 3000 determines whether or not both of the calculated total computer resource amounts are smaller than the amount of computer resources that the physical server 150 has.

In the case where the calculated total computer resource amounts are both smaller than the amount of computer resources of the physical server 150, the resource optimizing program 3000 determines that computer resources newly allocated by the execution of the scale-up processing can be secured from the physical server 150 on which the target VM 410 runs.

In a case of determining that computer resources newly allocated by the execution of the scale-up processing can be secured from the physical server 150 on which the target VM 410 runs, the resource optimizing program 3000 proceeds to Step S3290. This is because a situation in which necessary computer resources cannot be allocated is avoided without migrating the VM 410.

In a case of determining that computer resources newly allocated by the execution of the scale-up processing cannot be secured from the physical server 150 on which the target VM 410 runs, the resource optimizing program 3000 determines whether or not the physical server 150 from which computer resources necessary for the DB server 1430 can be secured is found among other physical servers 150 than the physical server 150 on which the target VM 410 runs (Step S3370). Step S3370 is the same as Step S3330.

In a case where it is determined that there is no physical server 150 from which computer resources necessary for the DB server 1430 can be secured, the migration of the VM 410 is not feasible and the resource optimizing program 3000 accordingly proceeds to Step S3290 without executing any particular processing.

In a case of determining that there is the physical server 150 from which computer resources necessary for the DB server 1430 can be secured, the resource optimizing program 3000 uses an existing technology to migrate the target VM 410 from the physical server 150 on which the target VM 410 has been running to the found physical server 150, without shutting down the target VM 410 (Step S3380). Thereafter, the resource optimizing program 3000 proceeds to step S3290.

A case where the target VM 410 runs on a specified physical server 150 may be considered. For example, the virtual-physical configuration management information T300 can include a column for setting a flag that indicates whether or not the VM 410 is to run on a fixed physical server 150. In this way, the VM 410 can be controlled so as not to migrate from the specified physical server 150 at the time when the relocation processing is started for the VM 410, or in Step S3340 or Step S3380.

A condition for preventing the VM 410 that corresponds to the primary DB server 1430 and the VM 410 that corresponds to the secondary DB server 1430 from running on the same physical server 150 or in the same cluster may be considered. The resource optimizing program 3000 in this case can exclude the physical servers 150 that match the condition from migration destination candidates in Step S3330 or Step S3370.

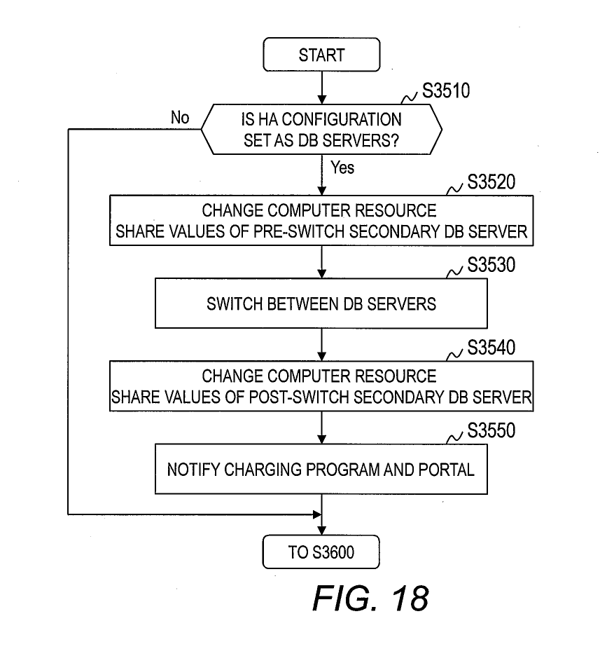

FIG. 18 is a flow chart illustrating details of the processing of scaling up the DB servers 1430 which includes the takeover processing and which is executed by the resource optimizing program 3000 of the first embodiment.

The resource optimizing program 3000 first determines whether or not there is the HA configuration built from the DB servers 1430 (Step S3510). For example, the resource optimizing program 3000 refers to the function (T440) of the tenant management information T400 or the configuration (T936) of the system template management information T900 to determine whether or not there is the HA configuration built from the DB servers 1430.

In the case where there is no HA configuration built from the DB servers 1430, the takeover processing cannot be executed and the resource optimizing program 3000 accordingly proceeds to Step S3600 without executing any particular processing.

In the case where there is the HA configuration built from the DB servers 1430, the resource optimizing program 3000 changes the share values of computer resources that are allocated to the secondary DB server 1430 (Step S3520). Specifically, the resource optimizing program 3000 searches the virtual-physical configuration management information T300 for a record of the VM 410 that corresponds to the secondary DB server 1430, and changes the value of the CPU share (T324), the memory share (T325), or the I/O share (T326) to “high” in the found record. At this point, the resource optimizing program 3000 notifies the change in share value to the hypervisor 400 via the configuration changing program 2300 or other components.

The resource optimizing program 3000 executes the takeover processing (Step S3530). Specifically, the resource optimizing program 3000 instructs the configuration changing program 2300 to execute the takeover processing.

After the takeover processing is completed, the resource optimizing program 3000 changes the share values of computer resources that are allocated to the post-switch secondary DB server 1430, i.e., the DB server 1430 that has been the primary before the execution of the takeover processing (Step S3540). Specifically, the resource optimizing program 3000 searches the virtual-physical configuration management information T300 for a record of the VM 410 that corresponds to the DB server 1430 that has become the secondary after the execution of the takeover processing. The resource optimizing program 3000 changes the value of the CPU share (T324), the memory share (T325), or the I/O share (T326) to “low” in the found record. At this point, the resource optimizing program 3000 notifies the change in share value to the hypervisor 400 via the configuration changing program 2300 or other components.

The resource optimizing program 3000 notifies information about the takeover processing to the charging program 2400 and the portal program 2100 (Step S3550), and then proceeds to Step S3600.

In the case of a charging system that is on a metered basis and that charges for the use of the primary DB server 1430 alone, charging that flexibly follows the takeover processing is accomplished by notifying information about the DB server 1430 to the charging program 2400. The portal program 2100 displays the information about the DB server 1430 on the portal 2000, thereby enabling the user 1100 to visually recognize the effects of the processing and the like.

In this embodiment, Step S3520, Step S3530, and Step S3540 are executed in the order stated. This is for securing the performance of the DB server 1430 without fail.

If Step S3520 is executed after Step S3530 or Step S3540, for example, the share values of computer resources allocated to the DB server 1430 that serves as the primary DB server 1430 after the takeover processing remains low. While this increases the amount of computer resources that are recognized by the primary DB server 1430, the amount of computer resources that are actually allocated to the primary DB server 1430 is small and the effect of the scale-up processing (takeover processing) is consequently not obtained.

Step S3520, Step S3530, and Step S3540 in this embodiment are therefore executed in the order stated in order to avoid the problem described above.

In the case where Step S3200 has not been completed at the time when the scale-up processing of FIG. 18 is started, the resource optimizing program 3000 may wait for the completion of Step S3200 to start the scale-up processing. In the case where the load is converged before the scale-up processing is completed, the resource optimizing program 3000 may skip the scale-up processing.

FIG. 19 is a flow chart illustrating details of processing of scaling down the scaled up DB servers 1430 which is executed by the resource optimizing program 3000 of the first embodiment.

The resource optimizing program 3000 first determines whether or not there is the HA configuration built from the DB servers 1430 (Step S3810). Step S3810 is the same as Step S3510.

In a case of determining that there is no HA configuration built from the DB servers 1430, the resource optimizing program 3000 returns the allocated computer resource amount and share values of the primary DB server 1430 to values prior to the execution of the scale-up processing (Step S3860), and then proceeds to Step S3850. For example, the resource optimizing program 3000 reduces the computer resource amount of the primary DB server 1430 concurrently with the execution of processing of scaling in the Web servers 1420.

In a case of determining that there is the HA configuration built from the DB servers 1430, the resource optimizing program 3000 returns the computer resource amount and share values of the secondary DB server 1430 to values prior to the execution of the scale-up processing (Step S3820). For example, the resource optimizing program 3000 refers to the scale management information T700 to return the computer resource amount of the secondary DB server 1430 to the original amount depending on how many Web servers 1420 are included after the processing of scaling in the Web servers 1420 is executed. At this point, the resource optimizing program 3000 notifies the changes in share value to the hypervisor 400 via the configuration changing program 2300 or other components.

In the case where a computer resource changing method that requires the shutting down of the relevant DB server 1430 is included, there is a chance that computer resources of the DB server 1430 that serves as the primary DB server 1430 after the execution of the takeover processing cannot be changed. The resource optimizing program 3000 therefore returns the computer resource state of the secondary DB server 1430 to a state prior to the execution of the scale-up processing, before executing the takeover processing.

The resource optimizing program 3000 executes the takeover processing (Step S3830). This returns the DB servers 1430 that are included in the tenant 1400 to a state prior to the execution of Step S3200.

After completing the takeover processing, the resource optimizing program 3000 returns the computer resource amount and share values of the secondary DB server 1430 to values prior to the execution of the scale-up processing (Step S3840). At this point, the resource optimizing program 3000 notifies the change in share value to the hypervisor 400 via the configuration changing program 2300 or other components.

After Step S3840 or Step S3860 is completed, the resource optimizing program 3000 notifies configuration information of the current tenant 1400 to the charging program 2400 and the portal program 2100 (Step S3850), and then proceeds to Step S3020.

For example, in the case of a charging system that is on a metered basis and that charges for the use of the primary DB server 1430 alone, charging that flexibly follows the scale-down processing is accomplished by notifying information about the DB server 1430 to the charging program 2400.

FIG. 21 is an explanatory diagram illustrating an example of a screen that is displayed in order to check the state of the tenant 1400 according to the first embodiment.

The screen of FIG. 21 which is denoted by 2050 is displayed when the user 1100, accesses the portal 2000 with the use of a Web browser, for example.

The screen 2050 displays state information 2060, which indicates the state of the tenant 1400 that is used by the user 1100, and an OK button 2070. Display items of the state information 2060 include a tenant ID (2061), a pattern (2062), a type (2063), and a state (2064).

The tenant ID (2061) is the same as the tenant ID (T620). The pattern (2062) is the same as the pattern ID (T640), and indicates a pattern selected in the field for the pattern input 2011. The type (2063) is the same as the type (T630), and indicates a type selected in the field for the type input 2012.

The state (2064) displays information that summarizes the state (T460), a scale up event or a scale down event that is output by the resource optimizing program 3000, or the like. Alternatively, the state (2064) may display the computer resource states of the servers (VMs 410) that from the tenant 1400, for example, the performance management information T500.

The user 1100 can visually confirm that the tenant 1400 that has a contract mode displayed by the type (2063) is running normally by referring to the state information 2060.

### Modification Example

The first embodiment has in mind a cloud service in a multi-tenant environment which has a plurality of tenants in one or more physical servers 150 in a mixed manner. This invention, however, is also applicable to a single-tenant environment which has only one tenant 1400 on one or more physical servers 150.

The first embodiment describes an example of application to public cloud, namely, an environment in which entities provide tenants for the users 1100 belonging to different organizations in a mixed manner. This invention is also applicable to private cloud, namely, an environment in which an information system division in a corporation provides tenants to divisions inside the corporation.

While IaaS is assumed in the first embodiment, the mode of providing may be PaaS.

While a premise of the first embodiment is that a three-tier Web system is built as a business operation system, this invention is also applicable to a single DB server 1430 by, for example, using the rate of increase in the number of SQL requests to the DB server 1430 in Step S3400. It is not always necessary for a business operation system to have the HA configuration built from the DB servers 1430.

While a server virtualization environment is a premise of the first embodiment, the DB servers 1430 and other components may be built from the physical servers 150 themselves. The same processing can be applied in this case by building the HA configuration and changing computer resources of the secondary DB server 1430 in a manner that involves shutting down the secondary DB server 1430.

According to this invention, processing of scaling up the DB servers 1430 which are the back end is accomplished with processing of scaling out the Web servers 1420 which are the front end, or other events, as a trigger. This enables a business operation system that includes a component incapable of scaling out to improve the processing performance on the back end following an improvement in processing performance on the front end, and to execute automatic scaling throughout the entire system.

Therefore, in a case where this invention is applied to, for example, a three-tier Web system that implements an online shopping system, an entity that runs the online shopping system can avoid a loss of opportunity for users of the online shopping and the like, and an investment cost of the online shopping system can be reduced.

Although the description of each embodiment has been given of the example that adopts software-based control, the control may be partly achieved by hardware.

This invention is not limited to the above-described embodiments but includes various modifications. The above-described embodiments are explained in details for better understanding of this invention and are not limited to those including all the configurations described above. A part of the configuration of one embodiment may be replaced with that of another embodiment; the configuration of one embodiment may be incorporated to the configuration of another embodiment. A part of the configuration of each embodiment may be added, deleted, or replaced by that of a different configuration.

The above-described configurations, functions, processing modules, and processing means, for all or a part of them, may be implemented by hardware: for example, by designing an integrated circuit.

The above-described configurations and functions may be implemented by software, which means that a processor interprets and executes programs providing the functions.

The information of programs, tables, and files to implement the functions may be stored in a storage device such as a memory, a hard disk drive, or an SSD (a Solid State Drive), or a storage medium such as an IC card, or an SD card.

The drawings shows control lines and information lines as considered necessary for explanation but do not show all control lines or information lines in the products. It can be considered that almost of all components are actually interconnected.

What is claimed is:

1. A computer system, comprising a plurality of computers,
wherein the plurality of computers include at least one first computer for managing the computer system, and a plurality of second computers for providing computer resources from which a business system used for a user's business operation is built,
wherein the at least one first computer includes a first processor, a first memory which is coupled to the first processor, and a first interface which is coupled to the first processor,
wherein each of the plurality of second computers includes a second processor, a second memory which is coupled to the second processor, a second interface which is coupled to the second processor, and a storage apparatus,
wherein the business system includes at least one of a first business computer capable of changing its processing performance by executing scale-out processing, and a plurality of second business computers capable of changing their processing performance by executing scale-up processing,
wherein the plurality of second business computers form at least one of a cluster including at least one of an active second business computer and at least one of a standby second business computer,
wherein the at least one first computer includes a resource optimizing module configured to manage a plurality of resource changing methods for controlling changes in allocation of the computer resources to the plurality of second business computers, and change the allocation of the computer resources to the plurality of second business computers based on the plurality of resource changing methods, and
wherein the resource optimizing module is configured to:
monitor load on the business system;
execute first processing for applying resource changing methods that are light in processing load to the at least one of the active second business computer and the at least one of the standby second business computer in a case of detecting an incident of an increase in load on the at least one of the active second business computer; and
execute second processing for applying resource changing methods that are heavy in processing load to the at least one of the active second business computer and the at least one of the standby second business computer in a case where a value indicating the load on the at least one of the active second business computer reaches a given threshold or higher.

2. The computer system according to claim 1,
wherein the plurality of resource changing methods include a plurality of first resource changing methods which are provided for each different type of the computer resources and which are executed without requiring a reboot of the relevant second business computer, and a plurality of second resource changing methods which are provided for each different type of the computer resources and which require a reboot of the relevant second business computer,
wherein, in the first processing, the resource optimizing module is configured to:
detect an increase in load on the at least one of the first business computer as an incident of an increase in load on the at least one of the active second business computer;
identify the type of the computer resource that is to be changed in the at least one of the active second business computer, and apply the first resource changing method that is associated with the identified computer resource type to the at least one of the active second business computer; and
identify the type of the computer resource that is to be changed in the at least one of the standby second business computer, and apply the second resource changing method that is associated with the identified computer resource type to the at least one of the standby second business computer, and
wherein, in the second processing, the resource optimizing module is configured to execute first switching processing for switching between the at least one of the active second business computer to which the first resource changing method has been applied and the at least one of the standby second business computer to which the second resource changing method has been applied.

3. The computer system according to claim 2, wherein the resource optimizing module is configured to:
apply to the second business computer, which changes to a standby second business computer from an active second business computer by executing the first switching processing, the second resource changing method for changing this second business computer back to a state prior to the application of the resource changing method based on the resource changing method that has been applied to this second business computer, in a case where the value indicating the load on the second business computer, which changes to the active second business computer from the standby second business computer by executing the first switching processing, becomes smaller than the given threshold;
execute second switching processing for switching between the second business computer, which changes to the active second business computer from the standby second business computer by executing the first switching processing, and the second business computer, which changes to the standby second business computer from the active second business computer by executing the first switching processing and to which the second resource changing method has been applied;
apply to the second business computer, which changes to the standby second business computer from the active second business computer by executing the second switching processing, the second resource changing method for changing this second business computer back to a state prior to the application of the resource changing method based on the resource changing method that has been applied to this second business computer.

4. The computer system according to claim 3,
wherein each of the plurality of second computers includes a virtualization module configured to manage virtual computers which are generated by logically partitioning the computer resources,
wherein the at least one of the first business computer and the plurality of second business computers are implemented with use of the virtual computers,
wherein the virtualization module sets share values for determining a rate at which the computer resources are distributed among a plurality of virtual computers managed by the virtualization module, and
wherein the first resource changing methods include changing methods for changing the share value of the identified computer resource type.

5. The computer system according to claim 4, wherein the resource optimizing module is configured to:
change the share values so that the standby second business computer to which the second resource changing method has been applied has the lowest computer resource distribution rate; and
change the share values so that the second business computer which changes to the active second business computer from the standby second business computer by executing the first switching processing has the highest computer resource distribution rate.

6. The computer system according to claim 4, wherein, in the first processing, after the first resource changing method that is associated with the identified computer resource type is applied to the at least one of the active second business computer, the resource optimizing module determines, based on the share values, whether or not the virtual computer that implements the at least one of the active second business computer is to be migrated from the second computer on which this virtual computer runs to another of the plurality of second computers.

7. The computer system according to claim 1,
wherein the at least one first computer includes a charging module configured to calculate an amount of usage fee for the user of the business system,
wherein, after the execution of one of the first processing and the second processing, the resource optimizing module notifies a result of the one of the first processing and the second processing to the charging module, and
wherein the charging module calculates an amount of usage fee for the user of the business system based on the notified result of the one of the first processing and the second processing.

8. The computer system according to claim 1, wherein the at least one first computer includes a user interface for notifying a state of the business system to the user of the business system after the execution of one of the first processing and the second processing.

9. A computer resource allocation management method performed in a computer system including a plurality of computers,
the plurality of computers including at least one first computer for managing the computer system, and a plurality of second computers for providing computer resources from which a business system used for a user's business is built,
the at least one first computer including a first processor, a first memory which is coupled to the first processor, and a first interface which is coupled to the first processor,
each of the plurality of second computers including a second processor, a second memory which is coupled to the second processor, a second interface which is coupled to the second processor, and a storage device,
the business system including at least one of a first business computer capable of changing its processing performance by executing scale-out processing, and a plurality of second business computers capable of changing their processing performance by executing scale-up processing,
the plurality of second business computers forming at least one of a cluster including at least one of an active second business computer and at least one of a standby second business computer,
the at least one first computer including a resource optimizing module configured to manage a plurality of resource changing methods for controlling changes in allocation of the computer resources to the plurality of second business computers, and change the allocation of the computer resources to the plurality of second business computers based on the plurality of resource changing methods,
the resource allocation management method including:
a first step of monitoring, by the resource optimizing module, load on the business system;
a second step of executing, by the resource optimizing module, first processing for applying resource changing methods that are light in processing load to the at least one of the active second business computer and the at least one of the standby second business computer in a case of detecting an incident of an increase in load on the active second business computer; and
a third step of executing, by the resource optimizing module, second processing for applying resource changing methods that are heavy in processing load to the at least one of the active second business computer and the at least one of the standby second business computer in a case where a value indicating the load on the at least one of the active second business computer reaches a given threshold or higher.

10. The computer resource allocation management method according to claim 9,
wherein the plurality of resource changing methods include a plurality of first resource changing methods which are provided for each different type of the computer resources and which are executed without requiring a reboot of the relevant second business computer, and a plurality of second resource changing methods which are provided for each different type of the computer resources and which require a reboot of the relevant second business computer,
wherein the second step includes:
a fourth step of detecting, by the resource optimizing module, an increase in load on the at least one of the first business computer as the incident of an increase in load on the at least one of the active second business computer;
a fifth step of identifying, by the resource optimizing module, the type of the computer resource that is to be changed in the at least one of the active second business computer, and applying the first resource changing method that is associated with the identified computer resource type to the at least one of the active second business computer; and
a sixth step of identifying, by the resource optimizing module, the type of the computer resource that is to be changed in the at least one of the standby second business computer, and applying the second resource changing method that is associated with the identified computer resource type to the at least one of the standby second business computer, and
wherein the third step includes a seventh step of executing, by the resource optimizing module, first switching processing for switching between the at least one of the active second business computer to which the first resource changing method has been applied and the at least one of the standby second business computer to which the second resource changing method has been applied.

11. The computer resource allocation management method according to claim 10, further including:
applying, by the resource optimizing module, to the second business computer, which changes to a standby second business computer from an active second business computer by executing the first switching processing, the second resource changing method for changing this second business computer back to a state prior to the application of the resource changing method based on the resource changing method that has been applied to this second business computer, in a case where the value indicating the load on the second business computer, which changes to the active second business computer from the standby second business computer by executing the first switching processing, becomes smaller than the given threshold;
executing, by the resource optimizing module, second switching processing for switching between the second business computer, which changes to the active second business computer from the standby second business computer by executing the first switching processing, and the second business computer, which changes to the standby second business computer from the active second business computer by executing the first switching processing and to which the second resource changing method has been applied;
applying, by the resource optimizing module, to the second business computer, which changes to the standby second business computer from the active second business computer by executing the second switching processing, the second resource changing method for changing this second business computer back to a state prior to the application of the resource changing method based on the resource changing method that has been applied to this second business computer.

12. The computer resource allocation management method according to claim 11,
wherein each of the plurality of second computers includes a virtualization module configured to manage virtual computers which are generated by logically partitioning the computer resources,
wherein the at least one of the first business computer and the plurality of second business computers are implemented with use of the virtual computers,
wherein the virtualization module sets share values for determining a rate at which the computer resources are distributed among a plurality of virtual computers managed by the virtualization module, and
wherein the first resource changing methods include changing methods for changing the share value of the identified computer resource type.

13. The computer resource allocation management method according to claim 12,
wherein the sixth step includes changing the share values so that the standby second business computer to which the second resource changing method has been applied has the lowest computer resource distribution rate, and
wherein the seventh step includes changing the share values so that the second business computer which changes to the active second business computer from the standby second business computer by executing the first switching processing has the highest computer resource distribution rate.

14. The computer resource allocation management method according to claim 12, wherein the fifth step includes determining, based on the share values, whether or not the virtual computer that implements the at least one of the active second business computer is to be migrated from the second computer on which this virtual computer runs to another of the plurality of second computers.

15. The computer resource allocation management method according to claim 9,
wherein the at least one first computer includes a charging module configured to calculate an amount of usage fee for the user of the business system, and
wherein the computer resource allocation management method further includes:
notifying, by the resource optimizing module, after the execution of one of the first processing and the second processing, a result of the one of the first processing and the second processing to the charging module; and
calculating, by the charging module, an amount of usage fee for the user of the business system based on the notified result of the one of the first processing and the second processing.
